(19) United States
(12) Patent Application Publication
(10) Pub. No.: US 2026/0220178 A1
(43) Pub. Date: Jul. 30, 2026

(54) SYSTEMS AND METHODS FOR IMPROVED SEARCH ON OBJECT STORAGE

(71) Applicant: Snark AI, Inc., Mountain View, CA (US)

(72) Inventors: Sasun Hambardzumyan, Yerevan (AM); Davit Buniatyan, Mountain View, CA (US)

(73) Assignee: Snark AI, Inc., Mountain View, CA (US)

(21) Appl. No.: 19/047,360

(22) Filed: Feb. 6, 2025

Related U.S. Application Data
(60) Provisional application No. 63/749,919, filed on Jan. 27, 2025.

(51) Int. Cl. G06F 16/334; G06F 16/35

(52) U.S. Cl. CPC G06F 16/3347; G06F 16/35

(57) ABSTRACT

Systems and methods for improved search on object storage are disclosed. A system can maintain a dataset comprising a plurality of samples respectively associated with a plurality of embeddings, where the embeddings correspond to an embeddings space. The system can generate a plurality of clusters based on the plurality of embeddings, with each cluster comprising a respective subset of embeddings and associated with a respective center within the embeddings space. The system can identify a query embedding for a search operation for the dataset. The system can select at least one cluster from the plurality of clusters based on the query embedding and the respective center of the at least one cluster. The system can generate query results based on a comparison of the query embedding and the embeddings of the cluster. The system can provide the set of query results in response to the search operation.

### CROSS-REFERENCES TO RELATED APPLICATIONS

This application claims the benefit of and priority to U.S. Provisional Ser. No. 63/749,919 , filed Jan. 27, 2025, the contents of which is incorporated herein by reference in its entirety for all purposes.

### BACKGROUND

Machine-learning datasets can be both large and varied, including large amounts of information in several different formats. The large size, complexity, and format of the dataset can create technical difficulties in managing and communicating the dataset between systems, storing the dataset, processing the dataset, and utilizing the dataset in machine-learning processes.

### SUMMARY

This disclosure relates to systems and methods for performing efficient vector search operations over large, distributed datasets. Traditional approaches to vector search, including exhaustive linear scans or approximate nearest-neighbor techniques such as Hierarchical Navigable Small World (HNSW), suffer from significant scalability and performance limitations, especially when dealing with large datasets. Conventional indexing methods, such as tree-based and hash-based indexes, become inefficient and cumbersome as datasets grow, leading to degraded search performance and excessive memory usage. For example, full linear scans of large datasets can be computationally intensive, resulting in slow search times and inefficient use of system resources.

To mitigate these challenges, the proposed techniques introduce a clustering-based vector search method that significantly improves search efficiency. The techniques described herein can implement clustering of a dataset into subsets of similar vectors to improve search performance. By segmenting the dataset into clusters, the need for a complete linear scan is reduced, thus enhancing the search speed and resource utilization. The clustering techniques described herein can be implemented to improve any type of search operation involving embeddings, vectors, or tensor-based datasets, including but not limited to text-based datasets or multimodal datasets. Additionally, the techniques described herein can be implemented using any suitable approach for similarity score calculation, and significantly improve performance over object-based storage systems.

One aspect of the present disclosure is directed to a system. The system can include one or more processors coupled to non-transitory memory. The system can maintain a dataset comprising a plurality of samples respectively associated with a plurality of embeddings, the plurality of embeddings corresponding to an embeddings space. The system can generate a plurality of clusters based on the plurality of embeddings, each of the plurality of clusters comprising a respective subset of embeddings of the plurality of embeddings, each of the plurality of clusters associated with a respective center within the embeddings space. The system can identify a query embedding for a search operation for the dataset. The system can select at least one cluster from the plurality of clusters based on the query embedding and the respective center of the at least one cluster. The system can generate a set of query results based on a comparison of the query embedding and the respective subset of embeddings of the at least one cluster, the set of query results comprising a subset of the plurality of samples. The system can provide the set of query results in response to the search operation.

In some implementations, the system can identify an input query for the search operation. In some implementations, the system can generate the query embedding based on the input query. In some implementations, the system can receive an additional sample to include in the dataset. In some implementations, the system can generate at least one embedding corresponding to the additional sample. In some implementations, the system can update the plurality of clusters based on the at least one embedding. In some implementations, the system can generate the plurality of clusters according to a k-means function.

In some implementations, the system can determine a number of clusters based at least on a number of the plurality of samples. In some implementations, the system can generate the plurality of clusters according to the number of clusters. In some implementations, the system can store the plurality of clusters in a remote storage. In some implementations, the system can retrieve the at least one cluster from the remote storage based at least on the query embedding. In some implementations, the system can calculate a respective distance between the query embedding and the respective center of each cluster of the plurality of clusters. In some implementations, the system can select the at least one cluster based on the respective distance between the query embedding and the respective center of each cluster.

In some implementations, the system can identify a plurality of electronic documents for inclusion in the dataset. In some implementations, the system can generate the plurality of embeddings based on the plurality of electronic documents. In some implementations, the system can update the dataset to include the plurality of embeddings and respective associations to the plurality of electronic documents. In some implementations, the system can receive a request for the search operation via an application programming interface (API) call. In some implementations, the system can provide the set of query results in response to the API call. In some implementations, the system can select a subset of clusters of the plurality of clusters, wherein a number of the subset of clusters is determined based on a number of the plurality of clusters. In some implementations, the system can generate the set of query results based on the comparison of the query embedding and the respective subset of embeddings of each of the subset of clusters.

One aspect of the present disclosure is directed to a method. The method can be performed, for example, by one or more processors coupled to memory. The method can include maintaining a dataset comprising a plurality of samples respectively associated with a plurality of embeddings, the plurality of embeddings corresponding to an embeddings space. The method can include generating a plurality of clusters based on the plurality of embeddings, each of the plurality of clusters comprising a respective subset of embeddings of the plurality of embeddings, each of the plurality of clusters associated with a respective center within the embeddings space. The method can include identifying a query embedding for a search operation for the dataset. The method can include selecting at least one cluster from the plurality of clusters based on the query embedding and the respective center of the at least one cluster. The method can include generating a set of query results based on a comparison of the query embedding and the respective subset of embeddings of the at least one cluster, the set of query results comprising a subset of the plurality of samples. The method can include providing the set of query results in response to the search operation.

In some implementations, the method can include identifying an input query for the search operation. In some implementations, the method can include generating the query embedding based on the input query. In some implementations, the method can include receiving an additional sample to include in the dataset. In some implementations, the method can include generating at least one embedding corresponding to the additional sample. In some implementations, the method can include updating the plurality of clusters based on the at least one embedding. In some implementations, the method can include generating the plurality of clusters according to a k-means function.

In some implementations, the method can include determining a number of clusters based at least on a number of the plurality of samples. In some implementations, the method can include generating the plurality of clusters according to the number of clusters. In some implementations, the method can include storing the plurality of clusters in a remote storage. In some implementations, the method can include retrieving the at least one cluster from the remote storage based at least on the query embedding. In some implementations, the method can include calculating a respective distance between the query embedding and the respective center of each cluster of the plurality of clusters. In some implementations, the method can include selecting the at least one cluster based on the respective distance between the query embedding and the respective center of each cluster.

In some implementations, the method can include identifying a plurality of electronic documents for inclusion in the dataset. In some implementations, the method can include generating the plurality of embeddings based on the plurality of electronic documents. In some implementations, the method can include updating the dataset to include the plurality of embeddings and respective associations to the plurality of electronic documents. In some implementations, the method can include receiving a request for the search operation via an application programming interface (API) call. In some implementations, the method can include providing the set of query results in response to the API call. In some implementations, the method can include selecting a subset of clusters of the plurality of clusters, wherein a number of the subset of clusters is determined based on a number of the plurality of clusters. In some implementations, the method can include generating the set of query results based on the comparison of the query embedding and the respective subset of embeddings of each of the subset of clusters.

At least one other aspect relates to a system. The system can include one or more processors coupled to non-transitory memory. The system can maintain a dataset comprising a plurality of electronic documents respectively associated with a plurality of sets of embeddings of an embeddings space. The system can generate a plurality of clusters, each of the plurality of clusters comprising one or more sets of embeddings of the plurality of sets of embeddings, each cluster corresponding to a respective center within the embeddings space. The system can identify a query embedding for a search operation for the dataset. The system can select at least one cluster from the plurality of clusters based on the query embedding and the respective center of the at least one cluster. The system can generate one or more similarity scores based on the query embedding and the one or more sets of embeddings of the at least one cluster. The system can select one or more electronic documents of the plurality of electronic documents based on the one or more similarity scores. The system can provide the one or more electronic documents in response to the search operation.

In some implementations, the system can generate a first set of embeddings for a first electronic document of the plurality of electronic documents using a vision transformer model. In some implementations, the system can generate a first output using a vision transformer model. In some implementations, the system can generate the first set of embeddings using at least one projection layer. In some implementations, the system can generate a set of patches from the first electronic document. In some implementations, the system can generate the first output using the vision transformer model and the set of patches. In some implementations, the system can update the projection layer using one or more training queries associated with the dataset.

In some implementations, the system can generate a transformed query embedding based on applying a transformation data structure to the query embedding. In some implementations, the system can generate the one or more similarity scores based on the transformed query embedding and the one or more sets of embeddings of the at least one cluster. In some implementations, the system can train the transformation data structure using a first set of embeddings corresponding to a first embeddings space and a set of ground-truth query results, the transformation data structure to transform the first set of embeddings to a second embeddings space.

In some implementations, the plurality of electronic documents can comprise one or more of image data or multimodal data. In some implementations, the plurality of clusters can be a first plurality of clusters. In some implementations, the system can generate a plurality of image embeddings based on a set of image data. In some implementations, the system can generate a second plurality of clusters based on the plurality of image embeddings. In some implementations, the system can select at least one second cluster from the second plurality of clusters based on the query embedding. In some implementations, the system can provide at least one image of the set of image data based on the at least one second cluster.

In some implementations, the system can generate encoded index data from a set of text data. In some implementations, the system can determine a similarity score between at least a portion of the encoded text data and the query embedding. In some implementations, the system can provide at least a portion of the set of text data based on the similarity score.

At least one other aspect relates to a method. The method can be performed, for example, by one or more processors coupled to non-transitory memory. The method can include maintaining a dataset comprising a plurality of electronic documents respectively associated with a plurality of sets of embeddings of an embeddings space. The method can include generating a plurality of clusters, each of the plurality of clusters comprising one or more sets of embeddings of the plurality of sets of embeddings, each cluster corresponding to a respective center within the embeddings space. The method can include identifying a query embedding for a search operation for the dataset. The method can include selecting at least one cluster from the plurality of clusters based on the query embedding and the respective center of the at least one cluster. The method can include generating one or more similarity scores based on the query embedding and the one or more sets of embeddings of the at least one cluster. The method can include selecting one or more electronic documents of the plurality of electronic documents based on the one or more similarity scores. The method can include providing the one or more electronic documents in response to the search operation.

In some implementations, the method can include generating a first set of embeddings for a first electronic document of the plurality of electronic documents using a vision transformer model. In some implementations, the method can include generating a first output using a vision transformer model. In some implementations, the method can include generating the first set of embeddings using at least one projection layer. In some implementations, the method can include generating a set of patches from the first electronic document. In some implementations, the method can include generating the first output using the vision transformer model and the set of patches. In some implementations, the method can include updating the projection layer using one or more training queries associated with the dataset.

In some implementations, the method can include generating a transformed query embedding based on applying a transformation data structure to the query embedding. In some implementations, the method can include generating the one or more similarity scores based on the transformed query embedding and the one or more sets of embeddings of the at least one cluster. In some implementations, the method can include training the transformation data structure using a first set of embeddings corresponding to a first embeddings space and a set of ground-truth query results, the transformation data structure to transform the first set of embeddings to a second embeddings space.

In some implementations, the plurality of electronic documents can comprise one or more of image data or multimodal data. In some implementations, the plurality of clusters can be a first plurality of clusters. In some implementations, the method can include generating a plurality of image embeddings based on a set of image data. In some implementations, the method can include generating a second plurality of clusters based on the plurality of image embeddings. In some implementations, the method can include selecting at least one second cluster from the second plurality of clusters based on the query embedding. In some implementations, the method can include providing at least one image of the set of image data based on the at least one second cluster.

In some implementations, the method can include generating encoded index data from a set of text data. In some implementations, the method can include determining a similarity score between at least a portion of the encoded text data and the query embedding. In some implementations, the method can include providing at least a portion of the set of text data based on the similarity score.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular forms of ‘a,’ ‘an,’ and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 illustrates a block diagram of an example data processing system that can implement techniques for training and applying transformation data structures, for example, in connection with tensor queries, in accordance with one or more implementations;

FIG. 2 illustrates an example dataflow diagram showing how transformation data structures are utilized in training and inference, in accordance with one or more implementations;

FIG. 3 illustrates a flow diagram of an example method of training and applying transformation data structures, in accordance with one or more implementations;

FIG. 4 illustrates a block diagram of an example data processing system that can implement techniques for improved search over object storage, in accordance with one or more implementations;

FIG. 5 illustrates an example dataflow diagram showing an example improved search process over object storage, in accordance with one or more implementations;

FIG. 6 illustrates a flow diagram of an example method of implementing improved search over object storage, in accordance with one or more implementations;

FIG. 7 illustrates a flow diagram of an example method of implementing improved bag-of-vectors search over object storage, in accordance with one or more implementations; and

FIG. 8 is a block diagram of an example data processing system and computing environment that may be utilized to perform various techniques or operations described herein, in accordance with one or more implementations; and

### DETAILED DESCRIPTION

Below are detailed descriptions of various concepts related to, and implementations of, techniques, approaches, methods, apparatuses, and systems for improved search operations. The various concepts introduced above and discussed in greater detail below may be implemented in any of numerous ways, as the described concepts are not limited to any particular manner of implementation. Examples of specific implementations and applications are provided primarily for illustrative purposes.

For purposes of reading the descriptions of the various implementations below, the following descriptions of the sections of the Specification and their respective contents may be helpful:
I. Section A describes systems and methods for training and applying transformation data structures, in accordance with one or more implementations.
II. Section B describes systems and methods for implementing various improved search techniques over object storage, in accordance with one or more implementations.
III. Section C describes a computing environment that may be useful for practicing the implementations described herein.

### A. Systems and Methods for Training and Applying Transformation Data Structures

The systems and methods of this technical solution provide techniques for training and applying transformation data structures, which can be used to transform input embeddings in a first embeddings space to map to a target corpus. Training can be performed using a training dataset that represents mappings and/or significance between input embeddings and a target embeddings corpus. Once trained, the transformation data structure can be utilized in a variety of computing operations and application, including but not limited to RAG. The techniques described herein provide improvements to the accuracy and speed of embeddings search operations (e.g., vector search operations in vector databases, etc.). Additionally, the use of the techniques described herein can be used to reduce the necessary size and complexity of input prompts for large language models (LLMs) or other machine-learning models, thereby improving overall computational performance of machine-learning systems that utilize embeddings.

The transformation data structures generated according to the techniques described herein can be used to map an input embeddings space to a target embeddings space and can be used in connection with any type of media modality. including text, images, video, or any other type of data for which embeddings can be generated. As such, the transformation data structures can be applied using the techniques described herein to effectively map embeddings of one media modality to another. For example, embeddings generated from text can be mapped to embeddings derived from image data using the transformation data structures described herein. The techniques described herein thereby extend the capabilities of systems that use embeddings by generating transformation data structures to map an arbitrary input embeddings space to an arbitrary target embeddings space.

Training, updating, or otherwise generating the transformation data structures can be performed according to a set of input example data mapped to a corresponding set of ground truth data. The ground truth data may correspond to portions of a pre-generated corpus of data having a target embeddings space, and may include additional metadata, such as significance scores, which can be used in the generation process for the transformation data structures described herein. In some implementations, machine-learning models (such as LLMs) can be used to generate labels for identified portions of a corpus based on a small number of examples.

Using the mappings between the example data and the corpus (or portions thereof), the systems and methods described herein can iteratively train the transformation data structure to map between generalized inputs from the input embeddings space to the target embeddings space of the corpus. The transformation data structures described herein can be applied for a variety of use cases, and improve the accuracy, efficiency, and computational performance of systems that process embeddings to perform various operations. Further details and improvements realized by this technology are described herein.

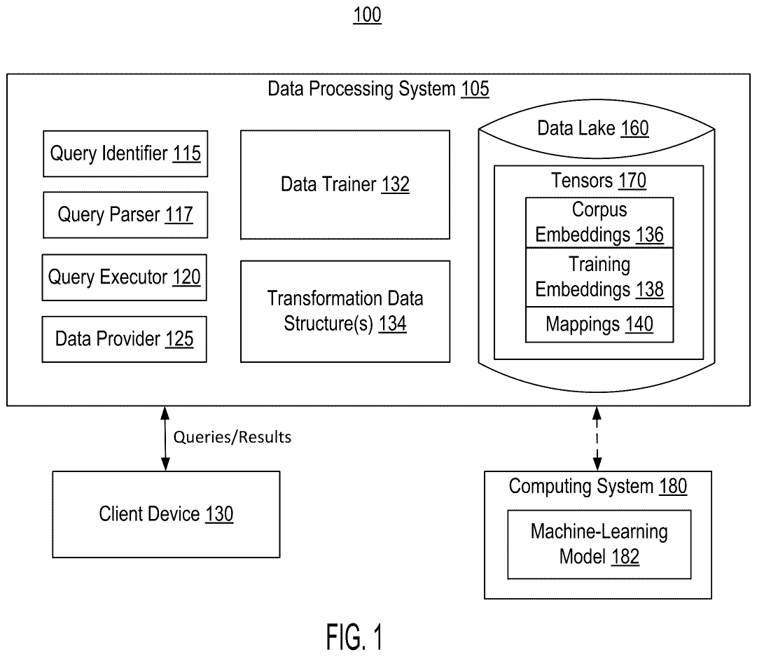

Referring now to FIG. 1, a data processing system 105 is shown that can implement techniques for training and applying transformation data structures 134, for example, in connection with tensor queries, retrieval augmented generation techniques, and/or general vector search operations, among others. The data processing system 105 can be a server system, a cloud-computing platform, a local computing system, a laptop computer, a desktop computer, a client device, or any other system that can process information. The data processing system 105 can be or include one or multiple computing nodes, servers, or distributed processing systems. The data processing system 105 can include a query identifier 115, a query parser 117, a query executor 120, a data provider 125, a data lake 160, a data trainer 132, and one or more transformation data structure(s) 134. The query identifier 115, the query parser 117, the query executor 120, the data provider 125, the data lake 160, the data trainer 132, and the transformation data structures 134 can include of software, applications, scripts, code, objects, hardware, the like, or combinations thereof that are configured to perform the various tasks, operations, and techniques described herein.

The query identifier 115, the query parser 117, the query executor 120, the data provider 125, the data lake 160, the data trainer 132, and the transformation data structures 134 can be implemented on a single data processing system 105 or implemented on multiple, separate data processing systems 105. The query identifier 115, the query parser 117, the query executor 120, the data provider 125, the data trainer 132, and/or the transformation data structure(s) 134 can be pieces of computer software, modules, software components, combinations of hardware and software components, or the like. Although various processes are described herein as being performed by the data processing system 105, it should be understood said operations or techniques may also be performed by other computing devices (e.g., the client device 130, the computing system 180), either individually or via communications with the data processing system 105. Similarly, other computing devices (e.g., the client device 130, the computing system 180) may include one or more of the components (e.g., the query identifier 115, the query parser 117, the query executor 120, the data provider 125, the data trainer 132, and/or the transformation data structure(s) 134) of the data processing system 105, and may carry out any of the various functionalities described herein.

The data lake 160 can be or include a data repository, a database, a set of databases a storage medium, a storage device, etc. The data lake 160 can store one or more tensors 170. The data lake 160 can store one or multiple different sets of tensors 170. For example, one set of tensors 170 can include one or more corpus embeddings 136, and another set of tensors 170 can include one or more training embeddings 138. Although shown as external to the data lake 160, in some implementations, the transformation data structures 134 can be stored in the data lake 160, for example, as one or more of the tensors 170 or otherwise. In some implementations, the transformation data structures are stored or otherwise maintained externally to the data lake 160, for example, in the memory of the data processing system 105, the client device 130, and/or the computing system 180.

The data lake 160 can be a computer-readable memory that can store or maintain any of the information described herein. The data lake 160 can store or maintain one or more data structures, which may contain, index, or otherwise store each of the values, pluralities, sets, variables, vectors, numbers, or thresholds described herein. The data lake 160 can be accessed using one or more memory addresses, index values, or identifiers of any item, structure, or region maintained in the data lake 160. The data lake 160 can be accessed by the components of the data processing system 105, or any other computing device described herein, for example, via suitable communications interface, a network, or the like. In some implementations, the data lake 160 can be internal to the data processing system 105. In some implementations, the data lake 160 can exist external to the data processing system 105 and may be accessed via a network or communications interface. The data lake 160 may be distributed across many different computer systems or storage elements.

The data processing system 105, the client device 130, and/or the computing system 180 can store, in one or more regions of the memory of the data processing system 105, or in the data lake 160, the results of any or all computations, determinations, selections, identifications, generations, constructions, or calculations in one or more data structures indexed or identified with appropriate values. Any or all values stored in the data lake 160 may be accessed by any computing device described herein, such as the data processing system 105, to perform any of the functionalities or functions described herein.

In some implementations, a computing device, such as a client device 130 and/or the computing system 180, may utilize authentication information (e.g., username, password, email, etc.) to show that the client device 130 and/or computing system 180 is authorized to access information the data lake 160 (or a particular portion of the data lake 160). The data lake 160 may include permission settings that indicate which users, devices, or profiles are authorized to access certain information stored in the data lake 160. In some implementations, instead of being internal to the data processing system 105, the data lake 160 can form a part of a cloud computing system. In such implementations, the data lake 160 can be a distributed storage medium in a cloud computing system and can be accessed by any of the components of the data processing system 105, by the one or more client devices 130 (e.g., via one or more user interfaces, etc.), or any other computing devices described herein.

In some implementations, the data processing system 105 can construct, generate, build, implement, or create one or more graphical user interfaces, which may be provided for display on the client device 130, and may display various data relating to queries, transformation data structures 134 (including training processes thereof), or any embeddings (or from which embeddings are generated) described herein, among other information. In some implementations, the data processing system 105 may provide display instructions to the client device 130 that cause the graphical user interface to be constructed, displayed, or rendered on the client device 130. The client device 130 may provide specified information via the graphical user interface.

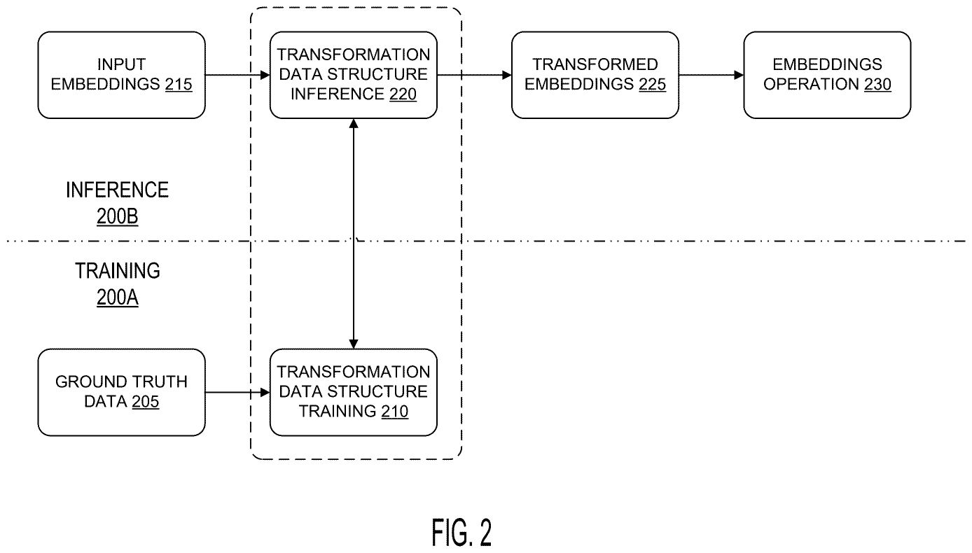

The data lake 160 can store one or more tensors 170 in one or more data structures, which may be stored in one or more chunks described in connection with FIG. 2. The tensors 170 can include multi-dimensional arrays (e.g., n-dimensional arrays). For example, a tensor 170 can be a first order tensor (e.g., a scalar), a second order tensor (e.g., a vector), a third order tensor (e.g., e.g., a matrix), a fourth order tensor, or any other higher order tensor. The tensors 170 can include embeddings data, image data, text data, audio data, video data (e.g., frames, etc.), tags, labels, binary code, or any other type of data that may be utilized in machine-learning processes or operations. For example, one or more tensors 170 may include embeddings vectors that numerically represent data of any suitable modality (e.g., text, images, video, other data, etc.), as described herein.

The tensors 170 storing the embeddings vectors (e.g., the corpus embeddings 136, the training embeddings 138, etc.) can be accessed to perform various embeddings/vector search operations, as well as to iteratively generate/train/update one or more transformation data structures 134. In some implementations, the tensors 170 (or any subsets thereof) may be stored as part of a vector database maintained in the data lake 160. For example, one or more of the corpus embeddings 136 and/or the training embeddings 138 may be stored as part of one or more vector databases maintained by the data lake 160. In some implementations, a respective vector database or other storage data structure may be implemented in the data lake 160 to store various sets of information (e.g., a respective data storage data structure for the corpus embeddings 136 and/or the training embeddings 138, etc.).

In some implementations, the tensors 170 can include information relating to supervised learning, such as ground truth classifications, significance scores, labels, or data from which embeddings are generated, for example, using an embeddings model. For example, the training embeddings 138, which are described in further detail herein, may include or be stored in association with various information that facilitates mapping to one or more embeddings in the corpus embeddings 136. For example, a training embedding 136 vector(s) may be stored in association with corresponding identifiers of embeddings in the corpus embeddings 136 to which the training embedding 136 vector(s) are mapped. Additional metadata may also be stored, for example, significance scores that are proportional to, or otherwise indicate a strength of, the corresponding mapping. As described in further detail herein, this information may be utilized to iteratively generate/train/update one or more transformation data structures 134.

In some implementations, the data lake 160 can store one or more tensors 170 in one or more multiple chunks (e.g., binary chunks). Chunks can be stored in one or more columns, rows, a matrix, or other suitable data structures in the data lake 160. For example, the data lake 260 can utilize a columnar storage architecture, with tensors 170 stored in columns of a dataset. Each tensor 170 can be stored in a collection of chunks, which can be binary blobs that contain one or more tensors 170. In some implementations, multiple tensors 170, each of which may be stored in a respective column of the data lake 160, can be associated with a respective sample identifier, such that a sample of the data lake 160 is indicated as including multiple tensors. In one example, a sample can be represented as a row in the data lake 160, with each column including a respective tensor for the corresponding sample. An index map associated with each tensor 170 maps a corresponding chunk and index of a sample within that chunk for a given sample index.

In some implementations, each column of the data lake 160 can represent a specific tensor type (e.g., associated with a corresponding tensor identifier), the binary data of which is stored in at least one corresponding chunk. The binary data stored in the chunks can include or represent multi-dimensional arrays (e.g., tensor 170 data, etc.). In some implementations, each column may store tensors 170 having different numbers of dimensions (e.g., each column can represent a tensor 170 having a different order or different tensor 170 size). As opposed to a document storage format, samples in the data lake 160 can be logically independent, enabling partial access to samples for running performant queries or streaming selected tensors over the network to graphics processing unit (GPU) training instances. Multiple tensors 170 can be grouped. Groups implement syntactic nesting and define how tensors 170 are related to each other. Syntactic nesting avoids the format complication for hierarchical memory layout. Changes to the data lake 160, or portions thereof, can be tracked over time with version control, similar to dataset content changes. The information stored in the data lake 160 may sometimes be referred to herein as a multi-dimensional sample dataset.

In some implementations, the tensors 170 can be typed and can be appended or modified in-place. Default access to an index or a set of indices can return the data as arrays or other suitable data structures (e.g., NumPy arrays, etc.). The tensors 170 can accommodate n-dimensional data, where the first dimension may correspond to the index or batch dimension. The tensors 170 can include dynamically shaped arrays, also called ragged tensors, as opposed to other statically chunked array formats. The tensors 170 may also have a variety of metadata, such as types, which describe the content or format of the tensor data.

Individual tensors 170, chunks, or samples (or portions thereof stored within the tensors) may be compressed during onboarding using a suitable compression algorithm. The compression algorithm may be selected based on the type of data that is being compressed. For example, images may be compressed using a first compression algorithm or format encoding, while labels may be compressed using a second, different compression or encoding. When the information in the tensors 170 are retrieved and processed, decompression may be performed by the requesting computing device, or may be performed by the computing device providing the tensors 170.

Various types of tensors 170 may be stored in the data lake 160, for example, including various corpuses of text data, image data, video data, or other types of data that may be utilized to generate one or more embeddings. For example, the tensors 170 can store a corpus of data, which can be or include a structured collection of texts or data that is used for linguistic or statistical analysis. Various information that may be included in the tensors 170 include sets of documents, articles, or texts that are gathered and organized for research, training, or other analytical purposes. The corpus embeddings 136 can include one or more sets of embeddings vectors generated from one or more corresponding corpora of information.

Each of a set of corpus embeddings 136 can be or include an n-dimensional vector that is generated from a common corpus of data (which itself may be stored in one or more tensors 170) to which the set of corpus embeddings 136 corresponds. A set of corpus embeddings 136 can include embeddings that are generated for a particular corpus of information, and therefore may correspond to a particular data modality (e.g., one of text data, image data, audio data, video data, etc.). Each set of corpus embeddings 136 can include any type of embedding and can share a common embeddings space.

An embeddings space is the continuous n-dimensional vector space within which each of the embeddings of a set of corpus embeddings 136 are defined. In an embeddings space, the position of a vector represents a relative meaning of the corresponding data within the larger scope of the embeddings space. Similar or related data items are typically positioned close to each other in the embeddings space, capturing the relationships between them by virtue of proximity. The distances and directions between vectors in this space reflect the similarities and differences between the corresponding data. The embeddings space can include the same number of dimensions as each embedding in a corresponding set of corpus embeddings 136. In some implementations, each set of corpus embeddings can be defined as associated with its own respective embeddings space. In some implementations, one or more sets of corpus embeddings 136 can be generated as sharing an embeddings space.

A set of corpus embeddings 136 for a data corpus can be generated using a corresponding embeddings model. In some implementations, the data processing system 105 can execute the embeddings model to generate a set of corpus embeddings 136 using a corresponding corpus of data as input (which may be stored as part of the tensors 170 in the data lake 160). The embeddings model can include any machine learning model for generating embeddings. The Embeddings model can include one or more computational functions that can be trained/updated to produce dense numerical representations of input data samples, which may be stored in the tensors 170. The embeddings model can include, execute, or utilize machine learning techniques, such as deep neural networks, to produce any of the embeddings described herein. For example, the embeddings model can use tensors 170 as input and apply a series of operations, transformations, or layers to extract meaningful features from the data stored therein and generate one or more corresponding embeddings vectors. These embedding vectors can capture semantic or contextual characteristics of the input data samples, allowing for efficient computation, analysis, and downstream tasks.

In some implementations, a respective embeddings model may be trained/updated/executed for each embeddings space utilized by the data processing system 105 for the techniques described herein. For example, one embeddings model may be trained/updated to generate a corresponding set of corpus embeddings 136 for a set of image data. Another embeddings model may be trained/updated to generate a corresponding set of corpus embeddings 136 for a set of text data.

In some implementations, the embeddings model utilized to generate a set of corpus embeddings 136 for a specified corpus of information can be specified in a request to generate the set of corpus embeddings 136. For example, the client device 130 and/or the computing system 180 can transmit a request (e.g., in response to user input, etc.) to generate a set of corpus embeddings 136 from a specified corpus of information (which may be specified via a location in the data lake 160). In response to the request, the data processing system can retrieve the corresponding corpus of data and provide said data as input to a corresponding embeddings model. In some implementations, the data processing system 105 can automatically select the embeddings model for generation of the corpus of embeddings 136, for example, based on the type of data in the specified corpus. For example, the data processing system 105 can select a text-specific embeddings model if the corpus of input data includes text data, or an image-specific embeddings model if the corpus of input data includes images. Similar approaches may be utilized for other types of embeddings.

In some implementations, the embeddings model can be executed by one or more external computing systems (e.g., the client device 130, the computing system 180) to generate the corpus embeddings 136. In some implementations, one or more sets of corpus embeddings 136 can be provided by an external computing system 180 for storage in the data lake 160. In such implementations, the data processing system 105 can receive various metadata to index or otherwise the store the received set(s) of corpus embeddings 136 in one or more tensors 170 in the data lake 160. The corpus embeddings 136 can be stored in association with one or more corpus identifiers, as well as an identifier of the embeddings space to which the corpus embeddings 136 correspond. Various additional metadata, such as identifiers of corresponding data or embeddings models used to generate the corpus embeddings 136, can be stored in the data lake 160.

To generate one or more transformation data structures, the data processing system 105 can utilize one or more training embeddings 138. The training embeddings 138 can be stored in association with corresponding mappings 140, which can map each set of training embeddings 138 to a corresponding set of results stored in a corresponding set of corpus embeddings 136. As described in further detail herein, input embeddings that may be used for techniques such as vector search, retrieval augmented generation, or general embeddings operation may be defined in a different, or subset of the embeddings space of corresponding corpus embeddings 136. To address this discrepancy, the data trainer 132 can generate, train, or otherwise update a transformation data structure 134 to automatically map the embeddings space of a set of training embeddings 138 to the embeddings space of the corresponding set of corpus embeddings.

The training embeddings 138 can be embeddings used as a set of training examples to generate a transformation data structure 134 based on the mappings 140 to corresponding portions of corresponding corpus embeddings 136. In one example, the training embeddings 138 can be embeddings generated from a particular query for which retrieval augmented generation is to be executed. Furthering this example, the corpus embeddings 136 that correspond to said training embeddings 138 can be embeddings of the corpus of information over which the retrieval augmented generation is to be executed. The training embeddings 138 may correspond to a subset of, or a different type of embeddings space than the corpus embeddings 136. To facilitate mapping between the different spaces, or to facilitate improved mapping within the same embeddings space, a transformation data structure 134 can be generated/trained/updated according to the techniques described herein to map the training embeddings 138 to the corpus embeddings 136.

In some implementations, multiple sets of training embeddings 138 and corresponding mappings 140 can be utilized to generate a transformation data structure 134. In one example, several hundred sets of training embeddings 138 and corresponding mappings 140 can be utilized in generating a transformation data structure 134 for a particular corpus (e.g., corresponding to a set of corpus embeddings 136). Each set of training embeddings 138 can represent a query, or set of data, which is to be used in a search or matching operation across the corresponding corpus. In one example, a query may be any type of text input that may be used to retrieve relevant information from a corresponding text, image, video, or audio corpus.

Embeddings for the query can be generated using similar techniques to those described herein (e.g., a corresponding embeddings model, etc.). The embeddings space for the training embeddings 138 may be different from that of the corpus embeddings 136 to which the training embeddings 138 correspond. For example, different embeddings models may be used to generate the corpus embeddings 136 and the corresponding training embeddings 138. In some implementations, the corpus embeddings 136 and the corresponding training embeddings 138 can be generated from the same embeddings model and share the same embeddings space. In such implementations, the transformation data structure 134 can be trained/updated/generated to better map embeddings generated from queries to relevant results in the corpus embeddings 136, achieving higher accuracy and performance when compared to conventional vector search operations.

In some implementations, the training embeddings 138 can be generated by the data processing system 105, the client device 130, and/or the computing system 180, using a corresponding set of query data or other input data and a selected embeddings model. The training embeddings 138 can be generated as an example that is used in connection with ground truth data to create a corresponding transformation data structure 134 using the techniques described herein. The ground truth data can be included in, or otherwise identified, by corresponding mappings 140. In some implementations, the mappings 140 can be generated in connection with the training embeddings 138.

A set of corresponding mappings 140, although shown as maintained in the data lake 160, can in some implementations be maintained in memory of the data processing system 105, the client device 130, and/or the computing system 180. Each mapping 140 in a set of mappings 140 can correspond to a respective query or input data used to generate a set of training embeddings 138. The mappings 140 can be explicit mappings (e.g., identifiers, memory locations, etc.) for relevant embeddings (e.g., vector search results) that are to be returned when executing vector search over a corresponding set of corpus embeddings 136 using a set of training embeddings 138. The mappings therefore define a ground truth for vector search operations, which can be used to generate/train/update a corresponding transformation data structure 134.

For example, a mapping 140 for a set of training embeddings 138 representing a vector search query may include, but is not limited to, identifiers of a set of corpus embeddings 136 that represent search results in the corresponding corpus that are determined to be relevant to the vector search query. In some implementations, mappings 140 may include significance scores for each of the relevant results for the vector search query. Each significance score can be a ground truth similarity value that is proportional to the desired similarity between the target embeddings 138 and the corresponding portions of the corpus embeddings 136 indicated as vector search results in the mappings 140.

The mappings 140 can be or include one or more data structures stored in association with a corresponding set of training embeddings 138. For example, the mappings 140 can be generated with the training embeddings 138 by identifying corresponding portions of the corpus relevant to the training embeddings 138. In some implementations, the mappings 140 can be generated prior to the training embeddings 138. For example, mappings 140 can first be generated as a list of portions of a corpus (e.g., lists of identifiers of corresponding portions of corpus embeddings 136) for which training embeddings 138 are to be generated. Once list of portions of the corpus have been identified, the corresponding portions of the corpus can be retrieved and used to generate a corresponding vector search input query (e.g., text data used to generate training embeddings 138).

Such queries may be generated via input to the data processing system 105, the client device 130, and/or the computing system 180, in some implementations. Similar input may be utilized to identify portions of the corpus (and/or corresponding corpus embeddings 136) that are to be included or otherwise identified in the mappings 140. As such, the mappings 140 can include identifiers of one or more portions of a corpus, acting as ground truth vector search results for a corresponding query. The ground truth search results listed as part of the mappings can include significance scores.

In some implementations, the data processing system 105 can utilize a corpus of data to generate corresponding mapping(s) 140 and/or training embeddings 138 automatically, for example, using a machine-learning model 182. In this example, the machine-learning model 182 is shown as being maintained and executed by a computing system 180. The computing system 180 can include one or more servers, computing systems, data centers (e.g., cloud computing systems), processors, and memory. The computing system 180 can be any type of computing system that can execute one or more machine-learning models 182. In some implementations, the computing system 180 can expose functionality of the one or more machine-learning models 182 to other computing systems (e.g., the client device 130, the data processing system 105, etc.) via one or more application programming interfaces (APIs).

The APIs can enable the data processing system 105 to provide information to the computing system 180 for use in executing the machine-learning model 182. Although further examples are described as the machine-learning model(s) 182 being executed by the computing system 180, it should be understood that in some implementations, the machine-learning model(s) 182 can be executed and/or maintained by any of the computing systems described herein, including the data processing system 105 and/or the client device 130.

In some implementations, the machine-learning model(s) 182 include one or more large-language models (LLMs). Large language models include generative models that are pre-trained on large amounts of text and can generate corresponding text in response to an input context. The input context can include text of arbitrary length, as well as requests corresponding thereto. In one example, the data processing system 105 can, given one or more identifiers of a corpus for which training embeddings 138 are to be generated, create a context for input to one or more of the machine-learning models 182.

To do so, the data processing system 105 can access and otherwise insert the data from the corpus into one or more templates for a given media type, corpus, or combinations thereof. The templates can be used to populate an example input context for a large language model (e.g., the machine learning model(s) 182). The data used to populate the template can include data from any suitable modality that is compatible with the machine-learning model 182, and may include text data, image data, video data, tensor data, audio data, binary data, or combinations thereof. The template can include any suitable data that forms a foundation for the context of the machine-learning model 182, and can include, for example, text that provides context for generating corresponding queries given an input context.

Said context data may include information (e.g., text data, etc.) that instructs the machine-learning model 182 to generate corresponding text-based queries that correspond to particular portions of a corpus (e.g., one or more portions of the corpus represented by the corpus embeddings 136). For example, the context data in a template may include instructions that cause the machine-learning model 182 to output one or more text-based queries for data in the corpus. In some implementations, the machine-learning model 182 may utilize one-shot or multi-shot generation. In such implementations, the context data in one or more templates can include previously generated example queries corresponding to portions of a corpus.

The previously generated example queries can be queries that are manually generated or may be previously executed queries over the same corpus. The portions of the corpus to which the queries correspond can be ground truth vector search results. As such, providing such examples to the machine-learning model 182 can instruct the machine-learning model 182 to generate text-based queries that would return a provided portion of a corpus of data if it were to be used in a vector search. In this way, the machine-learning model 182 can be utilized to generate synthetic training data (e.g., synthetic training embeddings 138) for a given corpus of information that is represented by one or more sets of corpus embeddings 136.

To generate the synthetic training embeddings 138 for a particular corpus represented by one or more sets of corpus embeddings 138, the data processing system 105 can populate one or more templates corresponding to the corpus, data types of the corpus, or default templates, among others. Populating the template can include inserting data (e.g., text data, etc.) from the corpus and/or training examples into the template. Once populated, the data processing system 105 can execute the machine-learning model 182 using the populated template (e.g., an input context) as input to the machine-learning model 182. In some implementations, the data processing system 105 itself can execute the machine-learning model 182. In some implementations, the data processing system 105 can execute the machine-learning model 182 by transmitting one or more API requests to the computing system 180, which subsequently executes the machine-learning model 182 to produce output data.

The output data produced by the machine-learning model 182 can be accessed, retrieved, or otherwise stored by the data processing system. As described herein, the input context for the machine-learning model 182 can cause the machine-learning model 182 to generate corresponding text-based queries that would result in the provided portions of a corpus being retrieved were the text-based query used in a search operation over said corpus of information. The machine-learning model 182 can be a general-purpose large language model, or a large language model that was specifically fine-tuned to generate text-based queries for input data. The text-based queries can operate as synthetically generated training data for training/updating/generating the transformation data structures 134 described herein.

Once the text-based queries have been generated by the machine-learning model 182, the data processing system 105 (or any other computing system described herein) can execute one or more embeddings models that generate corresponding synthetic training embeddings 138. If ground truth training embeddings 138 have already been generated, the synthetic training embeddings 138 can utilize the same embeddings model to generate the synthetic training embeddings 138 as was used to generate the ground truth training embeddings 138. The data processing system 105 then generate corresponding mappings 140 for the synthetic training embeddings 138 generated using the machine-learning model 182. The mappings 140 can identify the corresponding portions of the corpus (e.g., identifiers of corresponding set(s) of corpus embeddings 136) that were used in the input prompt to generate the synthetic text-based query. In some implementations, the machine-learning model 182 can generate a synthetic significance score, which may be included in the mappings for the synthetically generated training embeddings 138.

In some implementations, multiple vector search results may be returned from a vector search (e.g., in situations where multiple portions of a corpus are relevant to an input query). The mappings 140 can include a list of multiple identifiers of corresponding portions of the corpus embeddings 136, representing multiple ground-truth vector search results. Each identifier in the list can be stored in association with a respective significance score, thereby indicating the respective relevance between the respective result and the one or more training embeddings 138 of the mappings 140. Further, including multiple results in the mappings 140 for a set of training embeddings 138 can improve the accuracy of trained transformation data structures 134. The mappings 140 can be generated in connection with the techniques described herein, including but not limited to techniques based on large-language models (e.g., the machine-learning model 182), or manual processes, among others.

Referring now to processes for training/updating/generating one or more transformation data structures 134, the data processing system 104 can, in some implementations, initiate a process for training/updating/generating one or more transformation data structures 134 in response to a request from a computing system (e.g., a client device 130, the computing system 180, etc.) or in response to input to the data processing system 105 (e.g., via an input/output device, etc.). In some implementations, the request can include or may specify a location of training data (e.g., one or more sets of training embeddings 138, one or more mappings 140), as well as one or corpuses (e.g., corpus embeddings 136) for which the transformation data structure 134 is to be generated/trained/updated. Once the process to generate/train/update the transformation data structure 134 is initiated, the data trainer 132 can identify and/or retrieve training data to generate/train/update the transformation data structure 134.

The transformation data structure 134 can be a data structure that includes values that are applied to a set of input embeddings to transform the set of input embeddings, which corresponds to a source embeddings space, into a transformed set of embeddings that correspond to a target embeddings space. In some implementations, the source and target embeddings spaces can be the same embedding spaces, and the transformation data structure 134 can transform values of the input embeddings to different locations within the same embeddings space. As described herein, the transformed embeddings generated by applying the transformation data structure 134 to the input embeddings can more accurately identify relevant results for a vector search operation compared with the same operation using the set of input embeddings 138. As such, the application of the transformation data structure 134 improves the accuracy and performance of vector search by mapping the input embeddings into a different embeddings space, or different locations within the same embeddings space, to retrieve more accurate results in said embeddings space.

In some implementations, applying the transformation data structure 134 can include multiplying a set of weight values stored in the transformation data structure 134 by each of the embeddings in a set of input embeddings. As described herein, a set of embeddings can be embeddings that represent a particular portion of data, for example, a text string (e.g., a sentence). In an example of a text-based embedding, each word in the text string can be encoded as a n-dimensional vector of numbers. Furthering this example, the text string, when encoded as embeddings, can be represented as a sequence of embeddings vectors, with each word being represented as a respective embedding vector. Similar approaches may be utilized to generate embeddings for other types of data, including images, video, audio, or binary data, among others.

In one example, the transformation data structure 134 can be a matrix or tensor, with each element in the matrix or tensor comprising a value that is trained/updated/generated according to the techniques described herein. Furthering this example, applying the transformation data structure 134 may include performing an affine, or linear, transformation on one or more input embeddings (which may be vectors of numbers, e.g., floating-point numbers). In such implementations, the transformation data structure 134 may be applied to a vector of embeddings by performing a matrix/tensor multiplication operation between the vector of embeddings (which may represent a word, for example) and the transformation data structure 134. The shape of the matrix of the transformation data structure 134 may be selected such that the resulting output vector produced by the multiplication operation conforms includes the number of dimensions of the target embeddings space for which the transformation data structure 134 was generated.

In some implementations, the transformation data structure 134 can include a vector, with element in the vector comprising a value that is trained/updated/generated according to the techniques described herein. In such implementations, the number of dimensions in the vector transformation data structure 134 can be equal to the number of dimensions of the embeddings vectors of the source embeddings space and equal to the number of dimensions of the embeddings vectors of the target embeddings space (which may be, in some implementations, the same as the source embeddings space). In such implementations, applying the transformation data structure 134 can include performing an element-wise calculation between the transformation data structure 134 and each input embeddings vector.

In some implementations, the transformation data structure 134 can include one or more neural network layers, such as fully connected or sparsely connected neural network models. In such implementations, the input layer of the neural network can correspond to the number of dimensions of the input embeddings from a source embeddings space and the number of neurons in the output layer can correspond to the number of dimensions of the output embeddings for the target embeddings space. The transformation data structure 134 can be applied by providing an input embedding vector as input to the neural network and executing each layer of the neural network to produce an output vector. The output vector can be embeddings that have been mapped to the target embeddings space for which the transformation data structure 134 was generated.

Once the process to train/update/generate the transformation data structure 134 has been initiated, the data trainer 132 can generate the transformation data structure 134 for the corpus embeddings 136. To do so, the data trainer 132 can allocate one or more regions of memory in the data processing system 105 for the transformation data structure 134. In some implementations, the request to create the transformation data structure 134 can indicate a type of transformation data structure to generate. In such implementations, the data trainer 132 can generate the corresponding type (e.g., matrix, etc.) of the transformation data structure 134.

In some implementations, the data trainer 132 can determine the attributes (e.g., shape, etc.) of the transformation data structure 134 based on the training embeddings 138 and/or corpus embeddings 136 specified for the training process. For example, the data trainer 132 can generate a matrix having a number of rows or columns based on the number of elements in the embeddings array of each embedding in the training embeddings 138 (e.g., the number of embeddings in the embeddings space of the training embeddings 138). In some implementations, the data trainer 132 can generate a matrix having a number of rows or columns based on the number of elements in the embeddings array of each embedding in the training embeddings 138 and/or the corpus embeddings (e.g., the number of embeddings in the embeddings space of the training embeddings 138).

In implementations where the corpus embeddings 138 have a different number of elements than the target embeddings, the data trainer 132 can generate a transformation data structure 134 (e.g., a matrix, tensor, etc.) such that the output of applying (e.g., matrix multiplication, etc.) a target embedding 138 to the transformation data structure 134 results in an output having the same number of dimensions as the target embeddings space (e.g., of the corpus embeddings 136). Similar approaches may be performed to generate other types of transformation data structures 134, such as vector or neural network-based transformation data structures 134.

Once generated, and as described herein, the data trainer 132 can access or otherwise utilize a dataset (e.g., information in the data lake 160, specified via requests described herein, etc.) to map a first set of embeddings (e.g., training embeddings 138) generated in a first embeddings space to a set of query results, which may be specified in the mappings 140 associated with the specified training embeddings 138. As described herein, the query results may include, for a set of training embeddings 138 representing a query, one or more sets of the corpus embeddings 136 indicating a search result for vector/embeddings search operation over specified corpus embeddings 136. Both the sets of training embeddings 138, corresponding mappings 140, and the corpus embeddings 136 may be specified as part of the request to generate/train/update one or more transformation data structures 134.

The data trainer 132 can iteratively update values of the transformation data structure 134 by using the each of the training embeddings 138 as input, applying the transformation data structure 134 to the training embeddings 138 to generate output embeddings, and performing a similarity calculation between the output embeddings and the ground truth data (e.g., the corpus embeddings 136 identified in the mappings 140 corresponding to the input training data). The similarity calculation can be any suitable similarity calculation and may include but is not limited to cosine similarity, Euclidean distance, Manhattan distance, Jaccard similarity, or Pearson correlation coefficient, among others.

The similarity calculation can generate a similarity score that indicative of a similarity between the transformed embeddings produced by applying the transformation data structure 134 (e.g., an intermediate iteration of the transformation data structure 134 during optimization/training) to the input training embeddings 138, and corresponding corpus embeddings 136 identified in the mappings 140 for the input training embeddings 138. The similarity value can be used to calculate a loss, or error, between the expected output (e.g., a high similarity value, as the corpus embeddings 136 identified in the mapping are intended to be ground truth search results) and the actual similarity score generated via vector/embeddings search using the transformed embeddings.

In some implementations, weakly supervised learning techniques can be used to calculate the loss. For example, the presence or absence of the corresponding corpus embedding(s) 136 identified in the mappings 140 in the results of the vector search performed using the transformed embeddings can be used to calculate the loss. In some implementations, the mappings 140 may include negative search results, which are portions of the corpus embeddings 136 that are not to be mapped to the corresponding training embeddings 138 during of the transformation data structure 134. The presence of said negative results in the vector search using the transformed embeddings can increase the loss, representing an increased error. Similarly, the presence of positive (e.g., relevant) results in the vector search using the transformed embeddings can decrease the loss, representing a decreased error.

Any suitable loss function or combination of loss functions may be utilized to determine the loss for training the transformation data structure 134. In some implementations, different numbers of training embeddings 138 may be provided as input as batches or mini batches, the error for each of the which can be combined to generate the loss function. In some implementations, if a set of training embeddings 138 corresponds to a single query, said set of set of training embeddings 138 can be individually transformed to generate a corresponding set of transformed embeddings, after which the vector search is performed using the corresponding set of transformed embeddings over the corpus embeddings 136 to calculate the loss for the set of training embeddings 138 using the mappings 140, as described herein.

Once the loss is calculated, the parameters (e.g., values) of the transformation data structure, the data trainer 132 can execute an optimization technique (e.g., gradient descent or variant thereof, an Adam optimizer or variant thereof, etc.) to minimize the error of the loss function. The data trainer 132 can iteratively perform optimization, by incrementally modifying the values of the transformation data structure 134 (e.g., values stored in a matrix), and repeatedly retrieving and providing additional training embeddings 138 as input according to training hyperparameters (e.g., batch size, number of epochs, etc.). This process can be repeated until a training termination condition is reached.

In some implementations, a validation set, which may include data similar to that used for training/optimization (e.g., training embeddings 138 and corresponding mappings 140), may be utilized to evaluate the performance of the transformation data structure 134 during a training/updating process. For example, the validation set may include a subset of the training dataset that is set aside and used to test the accuracy of the transformation data structure 134. In a non-limiting example, the accuracy of the transformation data structure 134 may be tested periodically (e.g., after predetermined numbers of training/updating examples have been used to train/update the transformation data structure 134, etc.). This process can be repeated until a training termination condition is reached, such as an accuracy threshold being met or upon using a predetermined number of training/updating examples to train/update the transformation data structure 134. The data trainer 132 can therefore update/train the transformation data structure 134 using the training embeddings 138 and mappings 140, such that the transformation data structure 134 can map input embeddings in the embeddings space of the training embeddings 138 into the embeddings of the corpus embeddings 136, thereby improving the performance of vector/embeddings search operations.

Once trained, the data processing system 105 can store the transformation data structure 134 in association with the corpus embeddings 136 for which the transformation data structure 134 was generated. The data processing system 105, upon one or more corresponding requests (e.g., via a client device 130, computing system 180, input to the data processing system 105, etc.) can access and update the transformation data structure 134. Updating the transformation data structure 134 can be performed using additional training embeddings 138 and corresponding additional mappings 140, which may be specified in the request or otherwise accessed by the data processing system 105 in response to the request. For example, the request may include additional training embeddings 138 and mappings 140, or a client device 130 (or other computing system) may provide additional training embeddings 138 and mappings 140, which are accessed by the data trainer 132 to update the transformation data structure 134 using the techniques described herein.

The data trainer 132 can store the transformation data structure 134 in association with indications of the embeddings spaces and/or models for which the transformation data structure 134 is to be used. For example, the transformation data structure 134 can be stored in association with an identifier of the embeddings model or embeddings space of the training embeddings 138 used to train/update the transformation data structure 134, as well as an identifier of the embeddings model or embeddings space of the corpus embeddings 136. The data processing system 105 can utilize the transformation data structure 134 to perform embeddings/vector search operations over the corpus embeddings 136. In some implementations, the data processing system 105 can utilize an intermediate version (e.g., a snapshot) of the transformation data structure 134 that is produced during training/updating, but prior to completing the full training process for the transformation data structure 134.

Referring to the query/vector search processing functionality of the data processing system 105, the query identifier 115 can identify one or more queries for a vector search operation. The vector search operation can identify one or more corpuses of embeddings to search, such as the corpus embeddings 136, which as described herein can include a respective number of tensors 170 in the data lake 160. The query can include any number of nested queries or sub-queries, operations, commands, or Python/NumPy-style bracket or range notation. In some implementations, the query can specify one or more transformation operations, grouping operations, ungrouping operations, or sampling operations. Queries or requests for vector search operations over a set of corpus embeddings 136 may sometimes be referred to as a “search operation,” a “vector search operation,” a “vector search,” or a “request,” or a “query.”

The query identifier 115 can identify one or more search requests by receiving the queries/search requests from a computing device, such as the client device 130 or from an application, script, or other process executing on the data processing system 105, client device 130, or computing system 180. For example, the client device 130 may include a script that implements one or more APIs of the query identifier 115 and which provides the query identifier 115 with an indication of a query string/prompt, a corresponding identifier of the corpus embeddings 136 for which the search is to be executed, and in some implementations, an indication of an embeddings function with which to encode the input prompt/string.

In some implementations, the request can indicate a corresponding transformation data structure 134 to utilize for the embeddings search operation. In some implementations, the request can include an indication that an appropriate transformation data structure 134 is to be utilized for the search, and the query identifier 115 can identify the transformation data structure 134 based on the embeddings functions and/or corpus embeddings 136 specified in the request. For example, the transformation data structure 134 can select the transformation data structure 134 that has been trained over the specified set of corpus embeddings 136, and that has been trained using training embeddings 138 generated using the embeddings function specified in the request, if any. If no embeddings function is specified, the query identifier 115 can assume a generic or default embeddings function, select an embeddings function used to generate the specified corpus embeddings 136, or select an embeddings function used to generate the training embeddings 138 that trained the specified or identified transformation data structure 134. Any of the foregoing may be implemented according to internal configuration settings of the data processing system 105, or configuration settings specified by a client device 130 (or in the request). In some implementations, the client device 130 or the data processing system 105 can provide the query to the query identifier via a graphical user interface.

In some implementations, the vector search operation may be specified as part of a tensor query. Tensor queries can include both SQL keywords additional keywords that enable tensor-specific and dataset-specific functionality. For example, tensor queries can include range-based requests, which involve tensor slicing or indexing using Python or NumPy square bracket notation, for example. Range-based requests may be utilized to implement cropping functionality. Additionally processing keywords, such as normalization functions, mean, median, or mode functions, and addition/sum functions, among others, can be implemented as part of tensor queries, and may themselves operate on specified ranges or slices of tensors 170 in the multi-dimensional sample dataset. The queries can utilize additional square bracket notation to query multi-dimensional tensors 170. Queries can additionally include comparison operations for tensors 170 (or slices/indices of tensors), as well as tensor-based sums, multiplication operations, subtraction operations, division operations, or other mathematical operations.

In some implementations, the query identifier 115 may execute on the client device 130 as an embedded tensor searching engine and may be utilized either while training a model on a remote compute instance or in-browser compiled over WebAssembly. Once a query has been identified by the query identifier 115, the query can be passed to the query parser 117, which can parse the query to extract identifiers of the dataset, tensors 170 in the dataset, keywords, and user-defined functions, among other operations. In some implementations, the query parser 117 can perform a syntax checking operation to determine whether the syntax of the query is correct. For example, the query parser 117 can extract one or more string tokens from the query string in order and iterate over each string token and apply one or more tensor query syntax checking rules to determine whether the provided query is syntactically correct. The query parser 117 can determine whether specified transformation data structures 134 and corpus embeddings 136 exist in the data lake 160. Likewise, the query parser 117 can determine whether any specified embeddings functions can be executed by the data processing system 105, or if said embeddings functions are compatible with any specified transformation data structures 134.

If the query is determined to be syntactically correct, the query parser 117 can provide the query to the query executor 120 for execution. If a semantic error is detected in the query, the query parser 117 can generate an error message with an error identifier that identifies the error. The error identifier may be stored in association with the query, and the error message may be provided for display at the client device 130 or via a display device of the data processing system 105. In some implementations, the error message can include an indication of the location in query (e.g., the string token) where the error occurs, and may include an indication of the type of error or suggest a change to the query to make the query correct.

The query executor 120 can execute the vector search request/query by performing any operations for the query identified by the query identifier 115 and/or the query parser 117. Execution of the query can be delegated to external tensor computation frameworks such as PyTorch or XLA and efficiently utilize underlying accelerated hardware, in some implementations. The query executor 120 can execute the query/search operation by applying an identified or selected transformation data structure 134 to the data in the input query. In some implementations, prior to applying the transformation data structure 134, the query executor 120 can execute an embeddings function to generate a set of embeddings that represent the string/prompt in the request/query for the vector search operation. As described herein, the embeddings function may be specified in the query or identified based on the transformation data structure 134 and/or the specified corpus embeddings 136 that are to be searched.

The query executor 120 can execute the embeddings function using the input query string as input to generate a set of transformed query embeddings. The transformed query embeddings can correspond to a first embeddings space generated by the embeddings function, which may be different from the embeddings space of the corpus embeddings 136 that are to be searched. The query executor 120 can apply the transformation data structure 134 (trained/updated according to the techniques described herein) by performing operations described herein (e.g., matrix multiplication, element-wise product of vector, propagating through neural network, etc.). The query executor 120 can apply the transformation data structure 134 to each embeddings vector generated by executing the embeddings function over the input search query string. In some implementations, other data modalities (e.g., image(s), video(s), audio, etc.) may be provided in the input rather than a text string, and corresponding embeddings may be generated therefrom and used in connection with the transformation data structure 134, as described herein.

Once the transformed embeddings have been generated by applying the transformation data structure 134 to the input data in the query (or embeddings generated therefrom), the query executor 120 can execute a search operation over the corpus embeddings 136 specified in the request/query. To do so, the query executor 120 can execute a vector search operation. The vector search operation can include a similarity calculation between the transformed embeddings and the corpus embeddings 136 identified in the request/query. The similarity calculation can be any suitable similarity calculation and may include but is not limited to cosine similarity, Euclidean distance, Manhattan distance, Jaccard similarity, or Pearson correlation coefficient, among others.

As described herein, the corpus embeddings 136 may include multiple sets of embeddings data, which may represent portions of a larger corpus of data. In an example where the corpus of data is text information, each set of embeddings in the corpus embeddings 136 may correspond to a processed chunk, or portion, of the text information (e.g., a sentence, paragraph, predetermined number of words or characters, etc.). The similarity calculation can be performed for each set of embeddings data in the corpus embeddings and transformed embeddings in the query. The sets of embeddings data in the corpus embeddings 136 can be ranked according to the similarity score, and the query executor 120 can identify, in some implementations, a predetermined (or specified) number of top-scoring sets of embeddings data in the corpus embeddings 136. The query executor 120 can identify the data represented by the top-scoring corresponding sets of embeddings data in the corpus embeddings 136 from the data lake 160, which can be used to generate query results for the vector search operation.

In some implementations, the query executor 120 can generate a set of indices that point to locations of each tensor 170 storing the data represented by the top-scoring corresponding sets of embeddings data in the corpus embeddings 136 in the data lake 160. For example, once the relevant corpus embeddings 136 have been identified, and the data represented by said embeddings has been identified, a corresponding set of pointer values, references, or indices can be generated that identify the data of each result in the set of query results. The set of indices may be an array if the results are one-dimensional or may be a multi-dimensional data structure (e.g., a matrix, a tensor, etc.) if the set of query results return more than one type of tensor 170. In some implementations, the set of query results can be an array of indices that point to locations in the data lake 160 that store tensors 170 including the identified sets of embeddings data and information represented thereby.

In some implementations, the query executor 120 can format or transform the query result tensors 170, to conform to a particular shape or dimensionality specified in the query. Once generated, the set of query results can then be accessed by the data provider 125 to provide the set of query results as output. In some implementations, the query executor 120 can generate a set of query results by retrieving the data represented by the identified relevant corpus embeddings 136 and storing said data in one or more data structures. In some implementations, each query result can be stored in association with, or may include its respective similarity score. In some implementations, the data structure including the query results can be arranged or ordered according to the ranking of the query results.

The data provider 125 can provide the set of query results as output. The set of query results may be provided, for example, by the data provider 125 to a machine-learning system or process, such as a large language model or platform implementing retrieval augmented generation. In some implementations, the data provider 125 can provide the set of query results to the client device 130 or the computing system 180 (e.g., in a case where the client device 130 or the computing system 180 provided the query, and the data processing system 105 executed the query). In some implementations, the data provider 125 can provide the set of query results as indices that point to the tensor 170 data returned (or processed) from the query. Using the indices, the tensor 170 data corresponding to the query results can be retrieved from computer memory or from the data lake 160 (e.g., if the data was stored as a separate dataset, for example). In some implementations, the query results can include data retrieved form the data lake 160, which can be provided to the computing system (or process implemented by the data processing system 105) that provided the query/search operation.

The data provider 125 may store the set of query results in one or more data structures in the memory of the data processing system 105, the client device 130, or the computing system 180. The set of query results, or indices corresponding thereto, may be stored in association with the query from which the query results were generated. The set of query results may be cached and utilized in future queries or query operations, as described herein. The set of query results may be stored in a historic query database, for example, in association with the multi-dimensional sample dataset to which the query corresponds (e.g., if the dataset has write permissions for the user profile used to execute the query), or in the user profile used to execute the query. The data provider 125 may receive requests to execute historic queries/vector search operations and may provide the historic queries (and indications of any cached query results corresponding thereto) to the query identifier 115.

Although the foregoing descriptions of the query processing operations have been described herein as being performed by the data processing system 105, it should be understood that one or more of the operations of the data processing system 105 may instead be performed by the client device 130 and/or the computing system 180, or vice versa. For example, the client device 130 and/or the computing system 180 may perform any of the operations described herein, including but not limited to generating training data for training/updating/generating transformation data structures 134 using one or more machine-learning models 182 (e.g., large language models, transformer models, generative models, etc.), training/updating/generating transformation data structures 134, executing vector search queries using transformation data structures 134, and implementing said vector search results in machine-learning models (e.g., retrieval augmented generation), among others. Likewise, in some implementations, different querying operations may be performed by the data processing system 105 and the client device 130 and/or the computing system 180, with the query results being resolved via communications between the data processing system 105 and the client device 130 and/or the computing system 180.

Referring to FIG. 2 in the context of the components described in connection with FIG. 1, illustrated is an example dataflow diagram showing how transformation data structures 134 are utilized in training and inference, in accordance with one or more implementations. As shown, during a training process 200A, the transformation data structure 134 is trained using a ground truth example data 205 (e.g., the training embeddings 138 and corresponding mappings 140 to corpus embeddings 136, etc.), by iteratively updating the transformation data structure using the techniques described herein (e.g., the transformation data structure training process 210). In some implementations, the data processing system 105 can generate the training embeddings 138 and corresponding mappings 140 based on a set of input ground truth data 205 and corresponding mappings to portions of the corpus embeddings 136. Iteratively updating the transformation data structure 134 can be performed according to any suitable optimization technique. The trained transformation data structure 134 can be stored in association with the corpus embeddings 136 to which the transformation data structure 134 corresponds and can be used to improve the accuracy and performance of vector search operations, during an inference process 200B.

During the inference process 200B, the transformation data structure 134 is applied to a set of input embeddings 215, which can be any type of data that has been transformed into embeddings for use in a vector search operation, for example. In some implementations, the input embeddings 215 include embeddings generating using the same embeddings model used to generate the ground truth data 205. Applying the transformation data structure 134 can be performed according to the techniques described herein and can generate a set of transformed embeddings 225. The transformed embeddings 225can be embeddings transformed to conform to the embeddings space of the corpus. In some implementations, the embeddings space of the input embeddings 215 and the corpus embeddings 136 can be the same embeddings space, and the transformation data structure 134 can transform the input embeddings 215 into a representation that improves the perform of vector search in returning relevant results. As shown, the transformed embeddings 225 are used as input an embeddings operation 230. One example embeddings operation 230 is a vector search operation, in which the transformed embeddings are used as a query over the corpus embeddings 136 to generate a set of query results, as described herein.

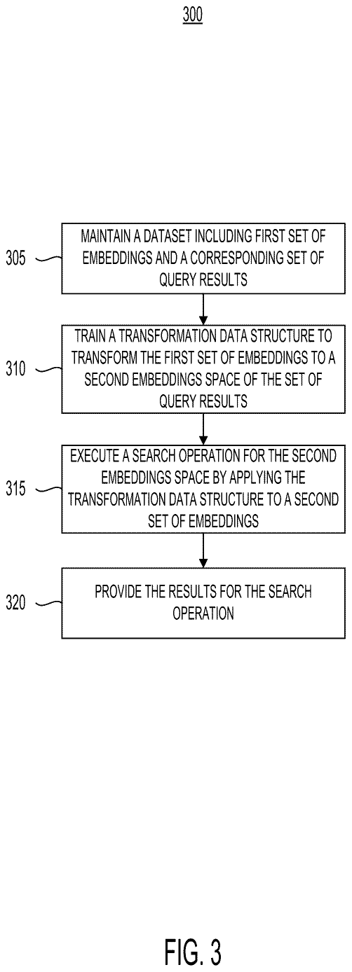

Referring to FIG. 3 in the context of the components described in connection with FIG. 1, illustrated is a flow diagram of an example method 300 of training and applying transformation data structures (e.g., the transformation data structures 134), in accordance with one or more implementations. The method 300 may be performed, for example, by the data processing system 105, the client device 130, the computing system 180, or any other computing system described herein. Although the method 300 is described as being performed by the data processing system 105, it should nevertheless be understood that any computing device may perform the various operations of the method 300 and communicate any results of the operations or intermediate computations relating to the operations to any other computing device described. The method 300 is described as having steps 305-320, however, it should be understood that the steps (referred to as ACTs) may be performed in any order, and that steps may be omitted, or additional steps may be performed to achieve useful results.

At ACT 305, the data processing system (e.g., the data processing system 105) can maintain a dataset including a first set of embeddings (e.g., the training embeddings 136) corresponding to a set of query results (e.g., portions of the corpus embeddings 136) for vector/embedding search operations. The first set of embeddings may sometimes be referred to as “training embeddings,” and the set of query results may sometimes be referred to as “corpus embeddings.” Maintaining the dataset can include, in some implementations, storing or receiving a corpus of data (e.g., text data, image data, video data, audio data, combinations thereof, etc.), generating embeddings for said corpus (e.g., the corpus embeddings 136) using an embeddings model, and storing said data in one or more vector databases (e.g., one or more sets of tensor 170 in the data lake 160). In some implementations, the data processing system may divide or otherwise process the corpus of data to generate multiple portions of the data. In an example where the portions include chunks of text data, corresponding corpus embeddings can be generated for each chunk of text data for inclusion in a set of corpus embeddings (e.g., the corpus embeddings 136) that represent the text information.

The first set of embeddings (e.g., training embeddings) can be embeddings used as a set of training examples to generate a transformation data structure (e.g., the transformation data structure 134) based on ground-truth mappings to corresponding portions of corresponding corpus embeddings (e.g., a second set of embeddings). In one example, the training embeddings can be embeddings generated from a particular query for which retrieval augmented generation is to be executed. Furthering this example, the corpus embeddings that correspond to said training embeddings can be embeddings of the corpus of information over which the retrieval augmented generation is to be executed. The training embeddings may correspond to a subset of, or a different type of embeddings space than the corpus embeddings. To facilitate mapping between the different spaces, or to facilitate improved mapping within the same embeddings space, a transformation data structure can be generated/trained/updated according to the techniques described herein to map the training embeddings to the corpus embeddings.

In some implementations, multiple sets of training embeddings and corresponding mappings can be utilized to generate a transformation data structure. In one example, several hundred sets of training embeddings and corresponding mappings can be utilized in generating a transformation data structure for a particular corpus (e.g., corresponding to a set of corpus embeddings). Each set of training embeddings can represent a query, or set of data, which is to be used in a search or matching operation across the corresponding corpus. In one example, a query may be any type of text input that may be used to retrieve relevant information from a corresponding text, image, video, or audio corpus.

Embeddings for the query can be generated using similar techniques to those described herein (e.g., a corresponding embeddings model, etc.). The embeddings space for the training embeddings may be different from that of the corpus embeddings to which the training embeddings correspond. For example, different embeddings models may be used to generate the corpus embeddings and the corresponding training embeddings. In some implementations, the corpus embeddings and the corresponding training embeddings can be generated from the same embeddings model and share the same embeddings space. In such implementations, the transformation data structure can be trained/updated/generated to better map embeddings generated from queries to relevant results in the corpus embeddings, achieving higher accuracy and performance when compared to conventional vector search operations.

The mappings can be or include one or more data structures stored in association with a corresponding set of training embeddings. For example, the mappings can be generated with the training embeddings by identifying corresponding portions of the corpus embeddings relevant to the training embeddings. In some implementations, the mappings can be generated prior to the training embeddings. For example, mappings can first be generated as a list of portions of a corpus (e.g., lists of identifiers of corresponding portions of corpus embeddings 136) for which training embeddings are to be generated. Once list of portions of the corpus have been identified, the corresponding portions of the corpus can be retrieved and used to generate a corresponding vector search input query (e.g., text data used to generate training embeddings 138).

In some implementations, the data processing system can utilize a corpus of data to generate corresponding mapping(s) and/or training embeddings automatically, for example, using a machine-learning model (e.g., the machine-learning model 182). In some implementations, the functionality of one or more machine-learning models 182 can be accessed via one or APIs. The APIs can enable the data processing system to provide information to the computing system (e.g., the data processing system 105, the computing system 180, the client device 130, etc.) executing the machine-learning model. In some implementations, the machine-learning model(s) include one or more LLMs. In one example, the data processing system can, given one or more identifiers of a corpus for which training embeddings are to be generated, create a context for input to one or more of the machine-learning models, as described herein. The machine learning model can be executed to generate corresponding training queries, which can be encoded using a corresponding embeddings model to generate the training embeddings (e.g., the first set of embeddings) corresponding to the mappings for the corpus dataset.

At ACT 310, the data processing system can train/update/generate a transformation data structure (e.g., the transformation data structure 134) to transform the first set of embeddings to a second embeddings space of the set of query results. In one example, the transformation data structure can be a matrix or tensor, with each element in the matrix or tensor comprising a value that is trained/updated/generated according to the techniques described herein. Furthering this example, applying the transformation data structure may include performing an affine, or linear, transformation on one or more input embeddings (which may be vectors of numbers, e.g., floating-point numbers). In such implementations, the transformation data structure may be applied to a vector of embeddings by performing a matrix/tensor multiplication operation between the vector of embeddings (which may represent a word, for example) and the transformation data structure. The shape of the matrix of the transformation data structure may be selected such that the resulting output vector produced by the multiplication operation conforms includes the number of dimensions of the target embeddings space for which the transformation data structure was generated.

In some implementations, the transformation data structure can include a vector, with element in the vector comprising a value that is trained/updated/generated according to the techniques described herein. In such implementations, the number of dimensions in the vector transformation data structure can be equal to the number of dimensions of the embeddings vectors of the source embeddings space and equal to the number of dimensions of the embeddings vectors of the target embeddings space (which may be, in some implementations, the same as the source embeddings space). In such implementations, applying the transformation data structure can include performing an element-wise calculation between the transformation data structure and each input embeddings vector.

In some implementations, the transformation data structure can include one or more neural network layers, such as fully connected or sparsely connected neural network models. In such implementations, the input layer of the neural network can correspond to the number of dimensions of the input embeddings from a source embeddings space and the number of neurons in the output layer can correspond to the number of dimensions of the output embeddings for the target embeddings space. The transformation data structure can be applied by providing an input embedding vector as input to the neural network and executing each layer of the neural network to produce an output vector. The output vector can be embeddings that have been mapped to the target embeddings space for which the transformation data structure was generated.

Once the process to train/update/generate the transformation data structure has been initiated, the data processing system can generate the transformation data structure for the corpus embeddings. To do so, the data processing system can allocate one or more regions of memory in the data processing system for the transformation data structure. In some implementations, the request to create the transformation data structure can indicate a type of transformation data structure to generate. In such implementations, the data processing system can generate the corresponding type (e.g., matrix, etc.) of the transformation data structure. The transformation data structure can be generated according to the techniques described herein (e.g., in connection with the data trainer 132 of FIG. 1).

Once generated, and as described herein, the data processing system can access or otherwise utilize a dataset (e.g., information in the data lake 160, specified via requests described herein, etc.) to map the first set of embeddings (e.g., training embeddings) generated in a first embeddings space to a set of query results, which may be specified in the mappings associated with the specified training embeddings. As described herein, the query results may include, for a set of training embeddings representing a query, one or more sets of the corpus embeddings indicating a search result for vector/embeddings search operation over specified corpus embeddings. Both the sets of training embeddings, corresponding mappings, and the corpus embeddings may be specified as part of the request to generate/train/update one or more transformation data structures.

The data processing system can iteratively update values of the transformation data structure by using the each of the training embeddings as input, applying the transformation data structure to the training embeddings to generate output embeddings, and performing a similarity calculation between the output embeddings and the ground truth data (e.g., the corpus embeddings identified in the mappings corresponding to the input training data). The similarity calculation can be any suitable similarity calculation and may include but is not limited to cosine similarity, Euclidean distance, Manhattan distance, Jaccard similarity, or Pearson correlation coefficient, among others.

The similarity calculation can generate a similarity score that indicative of a similarity between the transformed embeddings produced by applying the transformation data structure (e.g., an intermediate iteration of the transformation data structure during optimization/training) to the input training embeddings, and corresponding corpus embeddings identified in the mappings for the input training embeddings. The similarity value can be used to calculate a loss, or error, between the expected output (e.g., a high similarity value, as the corpus embeddings identified in the mapping are intended to be ground truth search results) and the actual similarity score generated via vector/embeddings search using the transformed embeddings.

In some implementations, weakly supervised learning techniques can be used to calculate the loss. For example, the presence or absence of the corresponding corpus embedding(s) identified in the mappings in the results of the vector search performed using the transformed embeddings can be used to calculate the loss. In some implementations, the mappings may include negative search results, which are portions of the corpus that are not to be mapped to the corresponding training embeddings during of the transformation data structure. The presence of said negative results in the vector search using the transformed embeddings can increase the loss, representing an increased error. Similarly, the presence of positive (e.g., relevant) results in the vector search using the transformed embeddings can decrease the loss, representing a decreased error.

Any suitable loss function or combination of loss functions may be utilized to determine the loss for training the transformation data structure. In some implementations, different numbers of training embeddings may be provided as input as batches or mini batches, the error for each of the which can be combined to generate the loss function. In some implementations, if a set of training embeddings corresponds to a single query, said set of set of training embeddings can be individually transformed to generate a corresponding set of transformed embeddings, after which the vector search is performed using the corresponding set of transformed embeddings over the corpus embeddings to calculate the loss for the set of training embeddings using the mappings, as described herein.

Once the loss is calculated, the parameters (e.g., values) of the transformation data structure, the data processing system can execute an optimization technique (e.g., gradient descent or variant thereof, an Adam optimizer or variant thereof, etc.) to minimize the error of the loss function. The data processing system can iteratively perform optimization, by incrementally modifying the values of the transformation data structure (e.g., values stored in a matrix), and repeatedly retrieving and providing additional training embeddings as input according to training hyperparameters (e.g., batch size, number of epochs, etc.). This process can be repeated until a training termination condition is reached.

In some implementations, a validation set, which may include data similar to that used for training/optimization (e.g., training embeddings and corresponding mappings), may be utilized to evaluate the performance of the transformation data structure during a training/updating process. For example, the validation set may include a subset of the training dataset that is set aside and used to test the accuracy of the transformation data structure. In a non-limiting example, the accuracy of the transformation data structure may be tested periodically (e.g., after predetermined numbers of training/updating examples have been used to train/update the transformation data structure, etc.). This process can be repeated until a training termination condition is reached, such as an accuracy threshold being met or upon using a predetermined number of training/updating examples to train/update the transformation data structure. The data processing system can therefore update/train the transformation data structure using the training embeddings and mappings, such that the transformation data structure can map input embeddings in the embeddings space of the training embeddings into the embeddings of the corpus embeddings, thereby improving the performance of vector/embeddings search operations.

At ACT 315, the data processing system can execute a search operation for the second embeddings space (e.g., over the corpus embeddings) by applying the transformation data structure trained in ACT 310 to a second set of embeddings (e.g., embeddings of an input vector search query). The second set of embeddings may be generated, for example, using a corresponding embeddings model used to generate the first set of embeddings (e.g., the training embeddings). If the vector search query includes a string, the data processing system execute the embeddings function using the input query string as input to generate a set of transformed query embeddings.

The transformed query embeddings can correspond to a first embeddings space generated by the embeddings function, which may be different from the embeddings space of the corpus embeddings that are to be searched. The data processing system can apply the transformation data structure (trained/updated according to the techniques described herein) by performing operations described herein (e.g., matrix multiplication, element-wise product of vector, propagating through neural network, etc.). The data processing system can apply the transformation data structure to each embeddings vector generated by executing the embeddings function over the input search query string. In some implementations, other data modalities (e.g., image(s), video(s), audio, etc.) may be provided in the input rather than a text string, and corresponding embeddings may be generated therefrom and used in connection with the transformation data structure, as described herein.

Once the transformed embeddings have been generated by applying the transformation data structure to the input data in the query (or embeddings generated therefrom), the data processing system can execute a search operation over the corpus embeddings specified in the request/query. To do so, the data processing system can execute a vector search operation. The vector search operation can include a similarity calculation between the transformed embeddings and the corpus embeddings identified in the request/query. The similarity calculation can be any suitable similarity calculation and may include but is not limited to cosine similarity, Euclidean distance, Manhattan distance, Jaccard similarity, or Pearson correlation coefficient, among others.

As described herein, the corpus embeddings may include multiple sets of embeddings data, which may represent portions of a larger corpus of data. In an example where the corpus of data is text information, each set of embeddings in the corpus embeddings may correspond to a processed chunk, or portion, of the text information (e.g., a sentence, paragraph, predetermined number of words or characters, etc.). The similarity calculation can be performed for each set of embeddings data in the corpus embeddings and transformed embeddings in the query. The sets of embeddings data in the corpus embeddings can be ranked according to the similarity score, and the data processing system can identify, in some implementations, a predetermined (or specified) number of top-scoring sets of embeddings data in the corpus embeddings. The data processing system can identify the data represented by the top-scoring corresponding sets of embeddings data in the corpus embeddings from the data lake 160, which can be used to generate query results for the vector search operation.

In some implementations, the data processing system can generate a set of indices that point to locations of the data represented by the top-scoring corresponding sets of embeddings data in the corpus embeddings. For example, once the relevant corpus embeddings have been identified, and the data represented by said embeddings has been identified, a corresponding set of pointer values, references, or indices can be generated that identify the data of each result in the set of query results. The set of indices may be an array if the results are one-dimensional or may be a multi-dimensional data structure (e.g., a matrix, a tensor, etc.) if the set of query results return more than one type of tensor. In some implementations, the set of query results can be an array of indices that point to locations in memory that store tensors including the identified sets of embeddings data and information represented thereby.

At ACT 320, the data processing system can provide the results for the search operation. The data processing system can provide the set of query results as output. The set of query results may be provided, for example, by the data processing system to a machine-learning system or process, such as a large language model or platform implementing retrieval augmented generation. In some implementations, the data processing system can provide the set of query results to a client device or a computing system (e.g., in a case where the client device or the computing system provided the query, and the data processing system 105 executed the query). In some implementations, the data processing system can provide the set of query results as indices that point to tensor data returned (or processed) from the query. Using the indices, the tensor data corresponding to the query results can be retrieved from computer memory or from a data lake (e.g., data lake 160, if the data was stored as a separate dataset, for example). In some implementations, the query results can include data retrieved form the data lake, which can be provided to the computing system (or process implemented by the data processing system 105) that provided the query/search operation.

The data processing system may store the set of query results in one or more data structures in the memory of the data processing system 105, the client device, or the computing system. The set of query results, or indices corresponding thereto, may be stored in association with the query from which the query results were generated. The set of query results may be cached and utilized in future queries or query operations, as described herein. The set of query results may be stored in a historic query database, for example, in association with the multi-dimensional sample dataset to which the query corresponds (e.g., if the dataset has write permissions for the user profile used to execute the query), or in the user profile used to execute the query. The data processing system may receive requests to execute historic queries/vector search operations and may provide the historic queries (and indications of any cached query results corresponding thereto) to a requesting device or user.

### B. Systems and Methods for Implementing Improved Search Over Object Storage

The present disclosure relates to systems and methods for executing improved search operations over distributed storage systems, such as object storage, by implementing clustering operations to enhance search efficiency. Vector search operations, such as embeddings search operations, are commonly used in various applications, including image and speech recognition, natural language processing, and recommendation systems, to identify nearest neighbors or similar vectors within a representative, high-dimensional vector space. Traditional search approaches, such as exhaustive linear scans or approximate nearest-neighbor search methods like Hierarchical Navigable Small World (HNSW), suffer from scalability issues and slow search performance, particularly when dealing with large datasets and memory constraints.

The techniques described herein can address these limitations by providing a clustering-based search approach, where embeddings representing a dataset are clustered and stored on object storage. Queries for the dataset may be received via any suitable interface, including API-based interfaces. When processing a query, similarity calculations can be performed between the centers of the clusters to identify candidate clusters that include results that satisfy the query. Individual searches can then be performed over the embeddings stored in each cluster to identify search results for the query. Search operations for each cluster can be computed in parallel, improving performance of search operations.

When processing the dataset, the systems and methods described herein can access clustered data in chunks, reducing memory requirements and enabling fast query times, and obviating the need for cache memories. In some implementations, the system can use commit-based clustering, where the clustering algorithm can be re-run, and new/additional clusters can be generated when data is committed to the dataset. By leveraging clustering operations and parallelized distance calculations, the system can efficiently execute vector search operations over large datasets, overcoming the limitations of conventional techniques and enabling fast and accurate search results over object storage.

Additionally, the techniques described herein can be used to perform search operations for any type of encoded representation of electronic data, including but not limited to embeddings for multimodal data or data structures such as “bags of embeddings,” which can represent portions of electronic documents. In such implementations, similar clustering approaches can be applied to sets, or “bags” of embedding vectors that collectively represent electronic documents, multimodal data, or portions thereof. As described herein, such approaches obviate the need for cache memory when performing search operations, significantly reducing cache memory requirements and search latency when performing search operations.

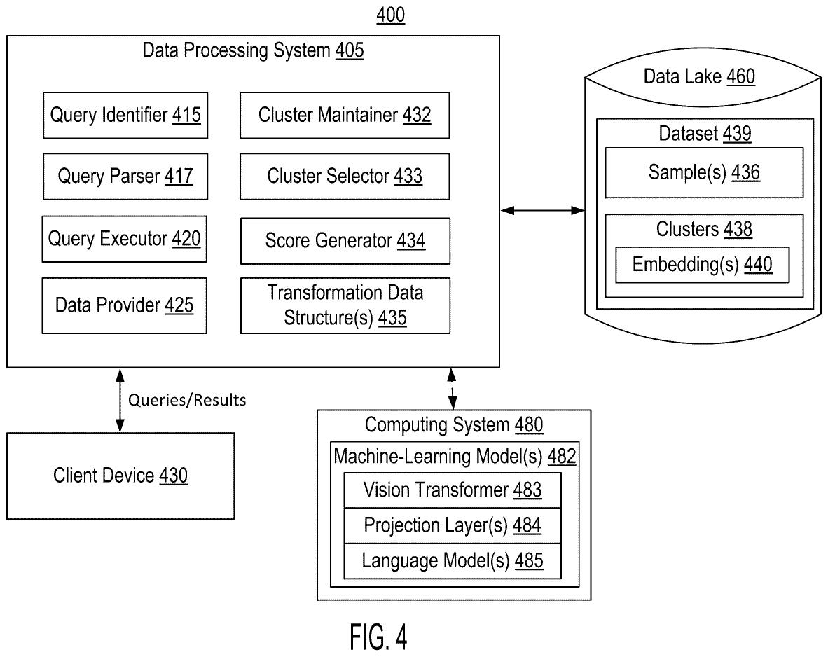

Referring to FIG. 4, a system 400 is shown as including a data processing system 405, a client device 430, a data lake 460, and a computing system 480. The data processing system 405 can implement techniques for implementing improved search over object storage, which in this example may be implemented as part of the data lake 160. The data processing system 405 can include a query identifier 415, a query parser 417, a query executor 420, a data provider 425, a cluster maintainer 432, a cluster selector 433, a score generator 434, and one or more transformation data structures 435. The data lake 460 is shown as including one or more datasets 439. An example dataset 439 is shown as including one or more samples 436 and one or more clusters 438 of embeddings 440. As described in further detail herein, the clusters 438 can include one or more sets of embeddings 440, which can represent corresponding samples 436 in the corresponding dataset 439. The computing system 480 is shown as including one or more machine-learning models 482, which may include language models, vision language models, or other types of machine-learning models that may access search results identified by the data processing system 405, as described herein.

As described herein, the query identifier 415, the query parser 417, the query executor 420, the data provider 425, the data lake 460, and the transformation data structures 435 can be similar to, and implement any of the structure and/or functionality of, the query identifier 115, the query parser 117, the query executor 120, the data provider 125, the data lake 160, and the transformation data structures 134 of FIG. 1. The query identifier 415, the query parser 417, the query executor 420, the data provider 425, the cluster maintainer 432, the cluster selector 433, and the score generator 434 can include hardware, software, applications, scripts, code, objects, the like, or combinations thereof that are configured to perform the various tasks, operations, and techniques described herein. As described herein, the data processing system 405 can be a server system, a cloud-computing platform, a local computing system, a laptop computer, a desktop computer, a client device, or any other system that can process information. The data processing system 405 can be or include one or multiple computing nodes, servers, or distributed processing systems.

The data processing system 405 can include any of the structure and implement any of the functionality of the data processing system 105 of FIG. 1. For example, the data processing system 405 can create and display graphical user interfaces on the client device 130. These interfaces may show data related to queries, transformation data structures 435, the data lake 460, clusters 438, samples 436, embeddings 440. The data processing system 405 may send display instructions to the client device 130, causing it to render one or more graphical user interfaces.

The client device(s) 430 can be similar to and implement any of the functionality, structure, or operations of the client device 130 of FIG. 1. In some implementations, the client device 430 can provide one or more requests to the data processing system 405, including any of the requests described herein. In some implementations, the client device 430 may communicate data for one or more samples 436 to the data processing system 405 and/or to the data lake 460. For example, the client device 430 may transmit one or more API calls to the data processing system 405 and/or the data lake 460 to commit one or more samples 436 (or data for samples) to the data lake 460 or datasets 439 thereof.

In some implementations, samples 436 may be generated and/or committed in the data lake 460 according to the techniques described herein. The client device 430 may transmit one or more search queries to the data processing system 405, which may be processed according to the techniques described herein. Search results (e.g., subsets of samples 436) generated and/or selected in response to queries can be provided to the client device 430 for further processing and/or display. In some implementations, retrieved search results may be provided to one or more downstream machine-learning operations, which may be implemented at the data processing system 405, the client device 430, and/or the computing system 480 (e.g., using the machine-learning model(s) 482).

The data lake 460 can be a computer-readable memory that can store or maintain any of the information described herein. In some implementations, the data lake 460 can be or include object storage. The data lake 460 can store or maintain one or more data structures, which may contain, index, or otherwise store each of the values, pluralities, sets, variables, vectors, numbers, or thresholds described herein. The data lake 460 can be accessed using one or more memory addresses, index values, or identifiers of any bucket, metadata, item, structure, or region maintained in the data lake 460. The data lake 460 can be accessed by the components of the data processing system 405, or any other computing device described herein, for example, via suitable communications interface, a network, or the like. The data lake 460 can be external to the data processing system 405 and may be accessed via a network or communications interface. The data lake 460 may be distributed across many different computer systems or storage elements. In some implementations, the data lake 160 may be at least partially internal to the data processing system 405. In some implementations, the data lake 460 may be part of one or more distributed computing systems (e.g., cloud computing systems). In some implementations, the data lake 460 and the data processing system 405 may be part of the same distributed computing system and/or communicate with one another via high-bandwidth network connections.

The data lake 460 can store one or more datasets 439, which are shown as including one or more samples 436 and one or more clusters 438. The clusters 438 can include one or more embeddings 440 that represent corresponding samples 436, as described in further detail herein. Although shown as a single dataset 439, it should be understood that the data lake 460 may store any number of datasets 439, each with corresponding samples 436, clusters 438, and/or embeddings 440. In some implementations, rather than storing clusters 438, a dataset 439 may include samples and corresponding embeddings 440 (e.g., to implement linear or tree-based search operations without necessarily using clusters). In some implementations, and as described in further detail herein, a dataset 439 may include an encoded index, such as a BM25 inverted index or a TF-IDF index, generated for samples 436 including text data. Different datasets 439 may include different samples 436 and different clusters 438 of embeddings 440 (or different sets of embeddings 440, encoded indexes, etc.). Each datasets 439 may be stored on index storage and may be updated using commit operations (e.g., transmitted by a client device 430 via one or more API calls, by an operator of the data processing system 406, etc.).

The data lake 460 can store one or more samples 436 that can be associated with one or more embeddings 440. The samples 436 stored in the data lake 460 can be any type of electronic data that is to be searched according to the techniques described herein. The samples 436 can include, but are not limited to, text-based data, image-based data, audio-based data, video-based data, or any other type of electronic data. The structure of the samples 436 can vary depending on the type of data being represented. For example, in the case of text-based data, the samples 436 can be or include electronic documents, text-based articles, source code documents, structured text-based data, or other types of text-based files or data structures. In the case of image-based data, the samples 436 can be images, videos (or frames thereof), or other types of visual information. The samples 436 can be stored in the data lake 460 in a variety of formats, such as files, records, or other types of data structures.

As described in further detail herein the samples 436 of a dataset 439 in the data lake 460 can be updated using commit operations, which in some implementations can initiate generation of one or more clusters 438 as described herein. When additional data is committed to a dataset 439 in the data lake 460, the data processing system 405 can generate new embeddings 440 for the data and store them in the dataset 439 as part of the samples 436 thereof. In some implementations, the data processing system 405 can then use clustering algorithms to group the new embeddings 440 with existing embeddings 440 in the dataset 439, generating one or more new clusters 438 or updating existing clusters 438. The clusters 438 can be used to improve the efficiency of search and retrieval operations, as described herein. In some implementations, the commit operations can be performed periodically, such as on a scheduled basis or in response to changes in the data as detected by the data processing system 104.

The data lake 460 can store one or more embeddings 440, which can be similar to the embeddings of FIG. 1 (e.g., the corpus embeddings 136, the training embeddings 138, etc.). As shown, the embeddings 440 may be stored in one or more clusters 438. The embeddings 440 can be encoded data that can represent corresponding samples 436 in the data lake 460. The embeddings 448 stored in the data lake 460 can be vector representations of data, which can be generated using various techniques, such as word embeddings, image embeddings, or multimodal embeddings, among others. The structure of the embeddings 448 can vary depending on the type of data being represented. In some implementations, the embeddings 448 can be high-dimensional vectors that capture the semantic meaning or features of the data. For example, in the case of text-based data, the embeddings 448 can be word embeddings that represent words or phrases as vectors in a high-dimensional space, where semantically similar words are mapped to nearby points. In some implementations, the embeddings 448 can be generated using machine learning models, such as neural networks, that are trained on large datasets to learn the patterns and relationships in the data.

The embeddings 448 can be generated from one or more electronic documents, text-based data, image-based data, multimodal data, or any other type of data, and can be used to represent the data in a manner that facilitates search operations. For instance, the embeddings 448 can be generated from text documents, such as articles, books, or websites, to represent the semantic meaning of the text. In some implementations, the embeddings 448 can be generated from image data, such as images or videos, to represent the visual features of the images. In some implementations, the embeddings 448 can be generated from multimodal data, such as text-image pairs, to represent the relationships between different modalities. The data represented by the embeddings 448 are stored in the data lake 460 as the samples 436, as described herein.

In some implementations, and as shown in this example, embeddings 440 of a dataset 439 can be grouped into one or more clusters 438. The clusters 438 can be generated using clustering algorithms, such as k-means or hierarchical clustering, that group similar embeddings 448 together based on their vector representations. The clusters 438 can be used to improve the efficiency of search and retrieval operations. In some implementations, the clusters 438 can be generated dynamically, based on data received and/or accessed by the data processing system 405, and can be updated periodically to reflect changes in samples 436. Different datasets 439 may include different embeddings 440, clusters 438, and samples 436. In some implementations, different datasets 439 may index data differently, for example, using BM25 or TF-IDF-based indexes, or using linear or tree-based storage for embeddings 440 rather than clusters 438.

In some implementations, the cluster maintainer 432 can store one or more samples 436 in the data lake 460, which can be any type of electronic data, such as text-based data, image-based data, audio-based data, video-based data, or multimodal data, as described herein. In some implementations, the cluster maintainer 432 can generate commits to one or more datasets 439 of the data lake 460 to store the sample(s) 436 and corresponding embeddings 440, which can be performed periodically, such as on a scheduled basis, or in response to a corresponding request (e.g., from a client device 430, from an operator of the data processing system 405, etc.). When additional sample(s) 436 are committed to a dataset 439 of the data lake 460, the cluster maintainer 432 can generate new embeddings 440 for the additional sample(s) 436 and store the embeddings 440 in the data lake 460 in association with identifier(s) of the corresponding sample(s) 436.

In some implementations, the cluster maintainer 432 can use clustering algorithms, such as k-means clustering, to group the new embeddings 440 with existing embeddings 440 in the data lake 460, generating one or more new clusters 438 or updating existing clusters 438. The commits can be used to update the data lake 460 with new or modified samples 436 and embeddings 440, which can be used to improve the efficiency of search and retrieval operations. In some implementations, the commit operations can initiate generation of one or more clusters 438. In some implementations, clustering may be initiated in response to a request from a client device 430, in response to requests from an operator of the data processing system 405, and/or according to a schedule for clustering (e.g., a predetermined schedule that may be stored as part of configuration settings of the data processing system 405).

The cluster maintainer 432 can use any suitable technique to generate clusters 438 of embeddings 440. As described herein, the clusters 438 can be used to improve the efficiency of search and retrieval operations. The clusters 438 can be generated using clustering algorithms, such as k-means or hierarchical clustering, that group similar embeddings 440 together based on their vector representations. As described herein, the cluster maintainer 432 can generate clusters using an iterative process. In some implementations, the cluster maintainer 432 can generate the clusters using an iterative k-means function. The number of iterations of the k-means function can be selected based on configuration settings stored at the data processing system 405 and/or identified from the requests to generate the clusters 438.

The cluster maintainer 432 can generate clusters 438 of embeddings 440 using a k-means clustering function, in some implementations. The k-means clustering function can start with an initialization step, where the cluster maintainer 432 can randomly select initial centers for each cluster 438 within the embeddings space of the embeddings 440. The cluster maintainer 432 can assign each embedding 440 to the cluster 438 with the closest center. The cluster maintainer 432 can update the center of each cluster 438, following the assignment of embeddings 440, by calculating the mean of all embeddings 440 assigned to that cluster 438. The cluster maintainer 432 can repeat the assignment and update steps until convergence or a stopping criterion is reached. The k-means clustering function can be used to generate clusters 438 of embeddings 440, where each cluster 438 includes embeddings 440 that are similar to each other.

This process can be repeated, where he cluster maintainer 432 can iteratively determine the center of each cluster 438 by calculating the mean of all embeddings 440 assigned to that cluster 438. The cluster maintainer 432 can use the updated centers to reassign each embedding 440 to the cluster 438 with the closest center. The cluster maintainer 432 can repeat this process until the centers of the clusters 438 converge or a stopping criterion is reached. In some implementations, the cluster maintainer 432 can use a fixed number of iterations, such as ten iterations, to determine the centers of the clusters 438. The cluster maintainer 432 can also use other stopping criteria, such as a maximum change in the centers of the clusters 438 or a minimum number of embeddings 440 in each cluster 438.

In some implementations, each cluster 438 can be represented using a data structure that includes a list of identifiers of embeddings 440 included in the cluster 438 or the actual embeddings 440 themselves. For example, in some implementations, the data structure can include a list of indices or pointers to the embeddings 440 in the data lake 460. The cluster maintainer 432 can use this data structure to efficiently store and retrieve the embeddings 440 in each cluster 438. In some implementations, one or more hyperparameters of the k-means clustering function, such as the number of clusters 438 and the maximum number of iterations, the distance metric of the clustering function, can be selected such that the size of the clusters 438 is on average a predetermined size, such as about 2000 embeddings 440 per cluster 438. The cluster maintainer 432 can use these hyperparameters to generate clusters 438 that balance the trade-off between the number of clusters 438 and the size of each cluster 438.

In some implementations, the cluster maintainer 432 can maintain or otherwise store one or more indexes for different types of data in the data lake 460. For example, the cluster maintainer 432 can store text-based data and/or electronic documents, such as scientific papers or other text-based documents, using indexes such as a best-match twenty-five (BM25) inverted index. The BM25 inverted index (or similar index, such as a Term Frequency-Inverse Document Frequency (TF-IDF) index, etc.) can be generated by the cluster maintainer 432 based on the text-based data stored in/committed to the data lake 460. In some implementations, the cluster maintainer 432 can also store other types of indexes, such as indexes for image-based data or audio-based data, using different indexing techniques.

In an example process for generating indexes for text-based data, the cluster maintainer 432 can tokenize the text-based data into individual words or phrases, and remove stop words and perform stemming or lemmatization to normalize the tokens. The cluster maintainer 432 can calculate the term frequency and inverse document frequency for each token in the electronic documents and/or portions of text data (e.g., one or more samples 436), and use these values to generate the BM25 inverted index. The BM25 inverted index can be stored in the data lake 460 in association with the samples 436 of text data to which it corresponds and can be used to efficiently search and retrieve text-based data. In some implementations, the cluster maintainer 432 can also store additional metadata, such as the title and author of each document, to facilitate searching and retrieval.

In some implementations, the cluster maintainer 432 can store both a search index, such as a BM25 inverted index, and embeddings 440, to facilitate a hybrid BM25 and vector search. The search index can be used to efficiently search and retrieve text-based data, while the embeddings 440 can be used to search and retrieve data based on semantic meaning, as described in further detail herein. For example, score generator 434 (described in further detail herein) can use the search index to generate a BM25 score for one or more corresponding samples 436, and use the embeddings 440 to calculate similarity scores between an input query embedding and the samples 436 (which may be implemented in part using the cluster selector 433, as described in further detail herein). The score generator 434 can combine both scores using corresponding weight values (e.g., set in configuration settings of the data processing system 105, specified in an input request and/or query, etc.) to generate a final similarity score for each sample 436. The data provider 425 can then generate search results having the sample(s) 436 having the greatest similarity score(s). Hybrid search according to these techniques can facilitate more accurate and efficient search and retrieval of data, even when using large datasets stored in object storage.

In some implementations, the cluster maintainer 432 can maintain or otherwise store one or more sets of embeddings 440 to represent electronic documents having multimodal data. The cluster maintainer 432 can store multimodal electronic documents, images, or other types of data using sets of embeddings 440, sometimes referred to as “bags” of embeddings 440 (or bags of vectors). The bags (or sets) of embeddings 440 can be generated upon receiving data to store within the data lake 460, for example, during dataset creation or commits to update one or more datasets in the data lake 460. The bags of embeddings 440 can be used to represent the semantic meaning of the electronic documents, and can be used for search and retrieval operations, as described herein. In some implementations, the cluster maintainer 432 can generate the bags of embeddings 440 by performing a series of steps, including document image processing, image segmentation, vision transformer encoding, contextualization via language model, and dimensionality reduction.

The cluster maintainer 432 can generate the bags of embeddings 440 by converting each electronic document into an image format, capturing all visual elements, including text, tables, figures, and layouts. The image can then be divided into a grid of patches (e.g., segments having predetermined dimensions, such as 32 by 32 pixels, etc.), with each patch representing a specific region of the page. The patches can be processed through one or more vision encoder layers of a vision transformer model 483, which can encode the visual features of the patches into a high-dimensional vector. Positional embeddings can be generated for each of the high dimensional vectors, to preserve and encode the relative positions of each patch with respect to other patches extracted from the electronic document. The vision transformer model 483 is shown as being part of the one or more of the machine-learning models 482 and can be used to generate the high-dimensional vectors and the contextualized embeddings for the patches. The vision transformer model 483 may include one or more encoder layers, such as convolutional layers, transformer layers, and/or fully connected layers. The contextualized embeddings can be generated by inputting the patch embeddings as “soft” tokens into one or more language models 485.

The contextualized embeddings can be projected to a lower dimension using one or more projection layers 484, such as fully connected layers, to generate the bag of embeddings 440 for the electronic document. The one or more projection layers 484 are shown as being part of the one or more machine-learning models 482. The projection layers 484 may include one or more fully connected layers and may be trained/updated according to one or more training processes. In some implementations, the cluster maintainer 432 can train/update one or more of the projection layers 484. The projection layers 484 can project the contextualized embeddings generated using the language model 485 to a lower dimensional, target embeddings space, such that the projected embeddings can be compared with embeddings of queries during search operations, as described herein.

The cluster maintainer 432 can train the projection layers 484 using a set of example training queries associated with corresponding samples 436 of the dataset 439. The training queries can be paired with the samples 436, sometimes referred to as query-document pairs or query-sample pairs, to form a training dataset. For example, the cluster maintainer 432 can use a set of training queries that are associated with a set of samples 436, where each sample 436 is a document or a portion of a document. The training queries can be used to fine-tune the projection layers 484, which can project the contextualized embeddings to a lower-dimensional format that is effective for search and retrieval operations over the samples 436 of the dataset 439.

In some implementations, the cluster maintainer 432 can generate synthetic queries from the samples 436 using one or more language models 485. The language models 485 can be used to generate synthetic queries that are similar but not identical to the one or more training queries and may be associated with different samples 436. The synthetic queries can be used to augment the training dataset, allowing the cluster maintainer 432 to train the projection layers 484 on a larger and more diverse set of queries. In some implementations, the synthetic queries may be generated by providing one or more samples 436 as input to the language model 485 with instructions to generate one or more synthetic queries for the sample 436. In some implementations, existing training queries may be provided as part of the instructions as examples from which the language model 485 can derive synthetic queries. The language models 485 (e.g., transformer-based models such as generative pre-trained transformer (GPT)-based models, etc.) can be trained on a large corpus of text, such as a dataset of documents or a corpus of web pages, and can be used to generate synthetic queries that are similar in style and structure to the training queries.

The cluster maintainer 432 can train the projection layers 484 using a fine-tuning process that involves optimizing a loss function, such as a contrastive loss function, to train the projection layer 484 to generate vectors that are aligned with desired embedding space. The fine-tuning process can involve iterating over the training queries and samples 436 for any number of training iterations, where the projection layers 484 are updated at each iteration to minimize the loss function. To calculate the loss for a training query, the cluster maintainer 432 can calculate a similarity score between the training query (e.g., processed into embeddings) and the bags of training embeddings generated from the samples 436 of the training dataset using the projection layers 485.

The loss can be formulated to maximize the similarity score of the correct (positive) query-sample pair while minimizing the scores of incorrect (negative) pairs. To do so, the cluster maintainer 432 may apply a softmax function over the generated similarity scores. The calculated loss can be backpropagated through the projection layers, updating the trainable parameters (e.g., weights) thereof. The cluster maintainer 432 can repeat the training process to update the parameters of the projection layers 484. In some implementations, different sets of projection layers 484 can be generated for different datasets 439. In such implementations, corresponding projection layers 484 may be retrieved/selected when adding samples 436 to those corresponding datasets 484. In some implementations, the projection layers 484 may be updated in response to one or more conditions, which may include adding samples 436 to the dataset 439 (e.g., when a predetermined number of additional samples 436 have been added to the dataset, in response to a request/signal from the client device 430 or an operator of the data processing system 405, etc.).

The trained projection layers 484 can be used to generate the bags of embeddings 440 for a dataset. The bags of embeddings 440 can be used to represent the semantic meaning of the electronic documents (e.g., the samples 436) of the dataset 439, and can be used for search and retrieval operations, as described in further detail herein. The cluster maintainer 432 can store the bags of embeddings 440 in the data lake 460 in association with corresponding samples 436 (e.g., electronic documents, etc.), and can use them to facilitate search and retrieval operations. As described in further detail herein, the score generator 434 can calculate a MaxSim score between one or more bags of embeddings 440 and a query embedding to generate search results and can return the search results to a client device 430 or other requesting system.

The projection layers may be included as part of the machine-learning model(s) 482 of the computing system 480. As described herein, although the machine-learning models 482 are shown as being external to the data processing system 405 (in this example, as part of the computing system 480, which is similar to the computing system 180 of FIG. 1), it should be understood that any of the machine-learning models described herein may be included as part of and executed by the data processing system 405. In some implementations, the data processing system 405 may execute any number of machine-learning models 482, including the vision transformer model 483, the projection layers 484, and/or the language model(s) 485.

In some implementations, the bags of embeddings 440 can be stored as part of a dataset 439 in the data lake 430, without necessarily generating clusters 438 of bags of embeddings 440. For example, and as described in further detail herein, in some implementations, the bags of embeddings 440 may be stored in one or more data structures that are structured to facilitate linear search or tree-based vector searching operations, such as lists or other types of suitable data structures. In such implementations, similarity scores can be calculated between input query embeddings and each bag of embeddings 440 using a MaxSim score, where relevant bags of embeddings 440 are identified using linear search, in one example.

In some implementations, the cluster maintainer 432 can generate one or more clusters 438 of bags of embeddings 440 using a clustering algorithm, such as k-means clustering. To do so, the cluster maintainer 432 can calculate the centroid of each bag of embeddings 440 (e.g., representing a sample 436 as described herein) by determining the mean of the embeddings 440 in the bag of embeddings 440. The mean can be calculated as a component-wise mean of the vectors of the bag of embeddings 440. The cluster maintainer 432 can use the centroid as the representation of the bag of embeddings 440 in the clustering process. For example, the cluster maintainer 432 can apply a k-means clustering algorithm, as described herein above, to the centroids of the bags of embeddings 440, grouping the centroids into clusters 438 based on their similarity. The cluster maintainer 432 can store identifiers of the bags of embeddings 440 corresponding to the centroids in each cluster together, thereby clustering the bags of embeddings 440 based on the similarity of their centroids.

As described herein, the cluster maintainer 432 can apply the k-means clustering algorithm to the bags of embeddings 440 in an iterative process, refining the clusters 438 based on the updated centroids at each iteration. The cluster maintainer 432 can continue the iterative process until convergence or until a stopping criterion is met, such as a maximum number of iterations or a minimum change in the cluster 438 assignments. The resulting clusters 438 can include multiple, similar bags of embeddings 440. In some implementations, the cluster maintainer 432 can perform the clustering algorithm to cluster the bags of embeddings 440 by using a MaxSim operator as a distance metric, where the distance of each cluster 438 is compared to a center point of a cluster using the MaxSim operation. In such implementations, the cluster maintainer 432 can use the MaxSim distance metric to compare the similarity between the bags of embeddings 440 and group the bags of embeddings 440 into the clusters 438 based on their MaxSim scores. The resulting clusters 438 of bags of embeddings 440 can be used to improve the efficiency of search and retrieval operations over object storage, as described herein.

Search operations can be provided by the client device 430, by an operator of the data processing system 405, and/or via one or more computing systems 480 (e.g., when executing machine-learning operations, etc.). The query identifier 415 can identify an input query for one or more search operations. The query can be a text-based query transmitted via an API call from a client device 430, via operator input to the data processing system 405, or from a computing system 480. For example, a user can enter a search query into a search bar on a client device 430, and the client device 430 can transmit the query to the data processing system 405 via an API call. The query identifier 415 can receive the query and the query extractor can validate the input query to determine whether the input query is valid, and to extract any relevant metadata, authorization data, or any other data described herein that may be used for search operations or other operations. In some implementations, the query can include one or more keywords, phrases, or other search terms that are used to identify relevant data in the data lake 460, e.g., a text query. In some implementations, the query may identify a dataset 439 to be searched, a type of search operation to perform (e.g., BM25, hybrid search, linear/tree-based search, cluster-based search, etc.).

In some implementations, the query can be transmitted or provided by the computing system 480 as part of a retrieval augmented generation (RAG) process. RAG is a process that uses a combination of retrieval and generation techniques to generate text or other data. In a RAG process, a language model (e.g., a language model 485) can be used to generate a prompt or query that is used to retrieve relevant data from the data lake 460. The query can be generated based on a prompt or input provided to the language model and can be used to retrieve relevant data from the data lake 460. For example, a language model can be used to generate a query such as “What are the latest research papers on machine learning?” and the query identifier 415 can identify this query as a valid input query for search operations. The query can be used to retrieve relevant data from the data lake 460, such as research papers or articles related to machine learning.

The query can identify a dataset 439 of the data lake 460 that is to be searched, or may include an identifier (e.g., user identifier, API key, etc.) from which an appropriate dataset 439 can be identified. For example, the query can include a dataset identifier or a keyword that is associated with a specific dataset 439 in the data lake 460. The query identifier 415 can use this information to identify the relevant dataset 439 and retrieve the relevant data. In some implementations, the query can include additional metadata, such as a user identifier or API key, which can be used to authenticate the user and authorize access to the relevant dataset 439. The query identifier 415 can use this metadata to verify the user's identity and authorize access to the relevant dataset 439.

The query parser 417 can extract a wide range of data from an input query, including but not limited to, dataset identifiers, keywords, user identifiers, API keys, authentication tokens, access control lists, dataset names, table names, column names, data types, query parameters, filtering criteria, sorting criteria, grouping criteria, aggregation functions, or other metadata, among other information. For example, the query parser 417 can extract information such as a specific dataset identifier, a keyword or phrase to search for, a user identifier or username, an API key or authentication token, a specific table or column name, a data type or format, a filtering criterion such as a date range or geographic location, a sorting criterion such as ascending or descending order, a grouping criterion such as grouping by category or time period, or an aggregation function such as sum or average. In some implementations, the query parser 417 can extract other metadata such as a query timeout value, a maximum number of results to return, a specific language or locale, role or permission data, or other context-specific information. In some implementations, the query may be received in a tensor query language format, as described herein. In some implementations, the query parser 417 can extract data from the query that is specific to the data lake 460, such as a specific data lake identifier or a storage location or region corresponding to the data lake 460. The query parser 417 can also extract data that is specific to the system or application making the query, such as an agent/user string, a client internet protocol (IP) address, or a request timestamp, among other data.

The query executor 420 can generate a query embedding for the search operation for the dataset 439. The query executor 420 can generate the query embedding based on the input query. The query embedding can be generated using approaches similar to those described in connection with the embeddings 440, such as using a machine learning model (e.g., an embeddings model), such as a neural network, a language model, or portion(s) thereof, to generate a vector representation of the input query. For example, the query executor 420 can use one or more layers of a machine-learning model 482 to generate a query embedding that captures the semantic meaning of the input query. In some implementations, the data processing system 405 can execute one or more of the machine-learning models 482 to generate the query embeddings. The query embedding can be a high-dimensional vector that represents the input query in a vector space, where similar queries are mapped to nearby points. In some implementations, the same embedding model used to generate the embeddings 440 to be searched can be used to generate the query embeddings. In some implementations, the embeddings model used to generate the query embeddings can be a different embeddings model that generates embeddings in the same embeddings space as the embeddings 440 of the dataset 439 to be searched.

The query embeddings can be generated using a variety of approaches. In some implementations, the query executor 420 can use a keyword extraction approach to extract relevant keywords from the input query and generate a query embedding based on the extracted keywords. In some implementations, the query executor 420 can use one or more transformation data structures 435 to generate a transformed query embedding. The transformation data structures 435 can be similar to and can be generated using any of the operations described in connection with the transformation data structures 134 of FIG. 1. A transformation data structure 435 may be generated for specific datasets 439 and/or sets of embeddings 440 of the data lake 460 and can be used to transform the query embedding into a transformed query embedding that is tailored to the specific dataset(s) 439 being searched. In some implementations, such as implementations where the media modalities of the input query and the samples 436 are different (e.g., text query to search images, etc.), the transformation data structures 435 can project the query embedding into the embedding space of the dataset 439, allowing the query embedding to be compared with the embeddings 440 of the dataset 439. The transformed query embedding can then be used to search the dataset 439 and retrieve relevant results. The transformation data structures 435 can be updated using training a process, as described herein.

The query executor 420 can initiate different types of search operations based on the input query or the dataset 439. The query executor 420 can determine which type of search operation to perform based on how the dataset 439 is indexed, such as BM25, TF-IDF, embeddings, clusters 438, or other indexing techniques. For example, if the dataset 439 is indexed using BM25, the query executor 420 can initiate a keyword search operation, while if the dataset 439 is indexed using embeddings, the query executor 420 can initiate a semantic search operation. In some implementations, the query executor 420 can identify the type of search operation to be performed based on metadata extracted from the input query, which may specify the type of search operation to be performed. In some implementations, the query executor 420 can initiate a cluster-based search operation. As described herein, in some implementations one or more embeddings 440 of a dataset 439 can be grouped in one or more clusters 440. To initiate the cluster-based search operation over object storage, the query executor 420 can provide the query embedding to the cluster selector 433 to select one or more clusters 439 from the dataset 439.

The cluster selector 433 can select at least one cluster 438 from a corresponding dataset 439 based on the query embedding and the centers of the clusters 438 of the dataset 439. The cluster selector 433 can access the dataset 439 to be searched to retrieve the center coordinates of each cluster 438, which can be stored in the dataset 439 or in a separate data structure in association with the dataset 439. The center coordinates can be used to represent the clusters 438 in a high-dimensional vector space, with each cluster 438 including embeddings that are close to one another in the high-dimensional vector space. The cluster selector 433 can use the center coordinates to compare the query embedding to the center of each cluster 438, generating a similarity score between the query embedding and each cluster 438.

The similarity score can be calculated using a distance metric, such as Euclidean distance or cosine similarity, and can be used to determine the similarity between the query embedding and each cluster 438. The cluster selector 433 can use the similarity scores to rank the clusters 438 in order of their similarity to the query embedding and can select one or more clusters 438 to perform further searching operations. The cluster selector 433 can select any number of clusters 438, balancing accuracy and search performance. For example, selecting too many clusters 438 can improve accuracy but may decrease search performance, while selecting too few clusters 438 can improve search performance but may decrease accuracy. The number of clusters selected may be specified in configuration settings of the data processing system 405, configuration settings of the dataset 439 being searched, may be specified in the query/search operation, or specified from any other source of settings/information.

The cluster selector 433 can select one or more clusters 438 of the dataset 439 based on the similarity scores. For example, to maximize performance, the cluster selector 433 can select only one cluster 438 having the highest similarity score, which can be the cluster 438 that is most similar to the query embedding. Alternatively, the cluster selector 433 can select a predetermined number of top-scoring clusters 438, such as the top 5 or top 10 clusters 438 with the highest similarity scores. In another example, the cluster selector 433 can select a number of clusters 438 that is proportional to the total number of clusters 438 in the dataset 439, such as the log₂ of the total number of clusters 438. In some implementations, the cluster selector 433 can use various techniques to select the clusters 438, including threshold-based selection, where clusters 438 with similarity scores above a certain threshold are selected, or rank-based selection, where a predetermined number of top-scoring clusters 438 are selected. In another example, the cluster selector 433 may select a top-scoring percentage of the clusters 438.

The score generator 434 can generate a set of query results based on a comparison of the query embedding and the respective embeddings 440 of each cluster 438 selected by the cluster selector 433. The score generator 434 can automatically retrieve the selected clusters from the data lake 460, for example, using fetch requests to retrieve the embeddings 440 of each cluster 438. The communications between the data processing system 405 and the data lake 460 can be high-bandwidth network communications, such as Ethernet or InfiniBand, which can improve the performance of the system by reducing the time it takes to retrieve the embeddings 440. The high-bandwidth network communications can also enable the system to handle large amounts of data and scale to meet the needs of large-scale applications.

The score generator 434 can generate similarity scores by comparing the query embedding to each of the embeddings 440 in each retrieved cluster 438. For example, the score generator 434 can use a cosine similarity metric to calculate the similarity between the query embedding and each embedding 440, or a Euclidean distance metric to calculate the distance between the query embedding and each embedding 440. The score generator 434 can also use other similarity metrics, such as Jaccard similarity, Hamming distance, or any other similarity score described herein, to calculate the similarity between the query embedding and each embedding 440. The similarity scores can be used to rank the embeddings 440 in each cluster 438, with the embeddings 440 having the highest similarity scores being ranked highest.

In some implementations, clusters 438 may include bags of embeddings 440, and the score generator 434 can compare the query embedding to each bag of embeddings in each cluster 438 using a MaxSim operation. To calculate a similarity score between a bag of embeddings 440 and the query using the MaxSim operation, the score generator 434 can tokenize the data string (e.g., the actual of the input query using a suitable tokenization process (e.g., a tokenizer corresponding to a language model such as a machine-learning model 482, etc.). Each token ca be converted into a N-dimensional vector using a language model, a trained neural network, or any other type of machine-learning model. Each N-dimensional vector can be an embedding with the same number of coordinates as each embedding in the bag of embeddings 440, such that they can be directly compared.

In some implementations, the score generator 434 can apply a transformation data structure 435 corresponding to the dataset 439 to one or more of the N-dimensional vectors, generating a transformed query embedding for each token. As described herein, the transformation data structure 435 can be learned during a training process and can be specific to the dataset 439, allowing the score generator 434 to generate one or more transformed query embeddings that are tailored to the specific characteristics of the dataset 439. For example, the transformation data structure 435 can be a linear or non-linear transformation that maps each N-dimensional vector to a new vector space corresponding to the bags of embeddings 440 of the dataset 439, such that the similarity between the query embedding and the bag of embeddings 440 can be more effectively calculated. In such implementations, the transformed query embeddings of each query token can be compared to the

The score generator 434 can generate a similarity score for each bag of embeddings 440 of each cluster 438 with respect to an input query via a MaxSim operation. The MaxSim operation can involve calculating the dot product of each query token embedding with every embedding in the bag of embeddings 440. The maximum similarity score for each query token is selected across all embeddings in a bag of embeddings 440, which identifies the document segment that best matches the specific query token. The maximum similarity scores for all query tokens are then summed to produce a final relevance score for the bag of embeddings 440 with respect to the input query. This process can be performed for each bag of embeddings 440 of each cluster 438 selected by the cluster selector 433.

Once the similarity scores have been generated, the score generator 434 can rank each embedding 440 (or bag of embeddings 440) according to the similarity scores. The score generator 434 can rank each embedding 440, or bag of embeddings 440, based on the similarity scores, with the embeddings 440 having the highest similarity scores being ranked highest. The score generator 434 can use various techniques to rank the embeddings 440, such as sorting the embeddings 440 in descending order of their similarity scores, or selecting a predetermined number of top-scoring embeddings 440, among others. In some implementations, the score generator 434 can use threshold-based ranking, where embeddings 440 with similarity scores above a certain threshold are selected, or rank-based ranking, where a predetermined number of top-scoring embeddings 440 are selected.

In addition to retrieving the embeddings 440 of the clusters 438 from the data lake 460, the score generator 434 can retrieve identifiers or storage location information for each corresponding sample 436 of the embeddings 440 of the retrieved clusters 438. In some implementations, the score generator 434 can select one or a number of top-scoring embeddings 440 according to the similarity scores and can retrieve the samples 436 associated with those embeddings to provide as the query results. For example, the score generator 434 can select the top-scoring sample 436, or a predetermined number of top-scoring samples 436, such as the top 5 or top 10 samples 436 with the highest similarity scores.

In some implementations, the score generator 434 can generate a set of fetch requests for the samples 436 associated with the embeddings 440 selected according to the ranking. The fetch requests can be generated based on the identifiers or storage location information retrieved by the score generator 434 and can include instructions to retrieve the corresponding samples 436 from the dataset 439. Each fetch request can specify the dataset 439, the identifier of the sample 436 to be retrieved, and any additional instructions for retrieving the data, such as the storage location or object storage system where the sample 436 is stored. The fetch requests can be transmitted to the data lake 460, which can retrieve the requested samples 436 from object storage or any other storage system and can return the retrieved samples 436 to the score generator 434. The score generator 434 can then use the retrieved samples 436 to generate the query results, which can include the samples 436 that are most similar to the query embedding. In some implementations, the query results can include the similarity scores, or any other metadata associated with the samples 436.

The data provider 425 can provide the set of query results in response to the search operation. The data provider 425 can receive the set of query results from the score generator 434, which can generate the query results based on the similarity scores calculated between the query embedding and the embeddings 440 in the dataset 439. The data provider 425 can provide the query results to the client device 430 and/or the computing system 480, which can use the query results for various purposes, such as displaying the results to a user or using the results as input for further processing. In some implementations, the data provider 425 can provide the set of query results in response to an API call provided by the client device 430 and/or the computing system 480. For example, the client device 430 can transmit an API call to the data provider 425, requesting the query results, and the data provider 425 can respond with the set of query results.

The search results provided by the data provider 425 can be used in various ways, including but not limited to in connection with a RAG operation. In a RAG operation, the search results can be used to generate output for one or more machine-learning operations, such as generating text or other data based on the search results. The search results can be used as input to a language model 485, which can generate text based on the search results. Search results can be included in one or more input prompts for a language model 485, such as a prompt that asks the language model 485 to generate a summary of the search results or to generate a response based on the search results. The language model 485 can generate output based on the prompt, using the search results as context. The output generated by the language model 485 can be used for various purposes, such as displaying the output to a user or using the output as input for further processing. The data provider 425 can provide the search results to the language model 485, which can process the results to generate the output.

In some implementations, the number of search results to be returned can be specified in the search query or filtered at the device that receives the query to perform machine-learning operations. For example, the search query can include a parameter that specifies the number of search results to be returned, such as a limit or offset parameter, which can be used by the data provider 425 to filter the search results. Alternatively, the device that receives the query, such as the client device 430 or the computing system 480, can filter the search results based on the specific requirements of the RAG operation. For example, the device can filter the search results to return only the top-N results, where N is a predetermined or dynamically determined number, or to return results that meet certain criteria, such as a minimum similarity score or a specific relevance threshold. The filtered search results can then be used as input to a language model 485 or other machine-learning model to generate output, such as text or other data, based on the search results. The ability to specify or filter the number of search results to be returned can be useful in various RAG operations, such as question answering, text generation, or conversational dialogue systems, where the number of relevant search results can affect the quality and accuracy of the generated output.

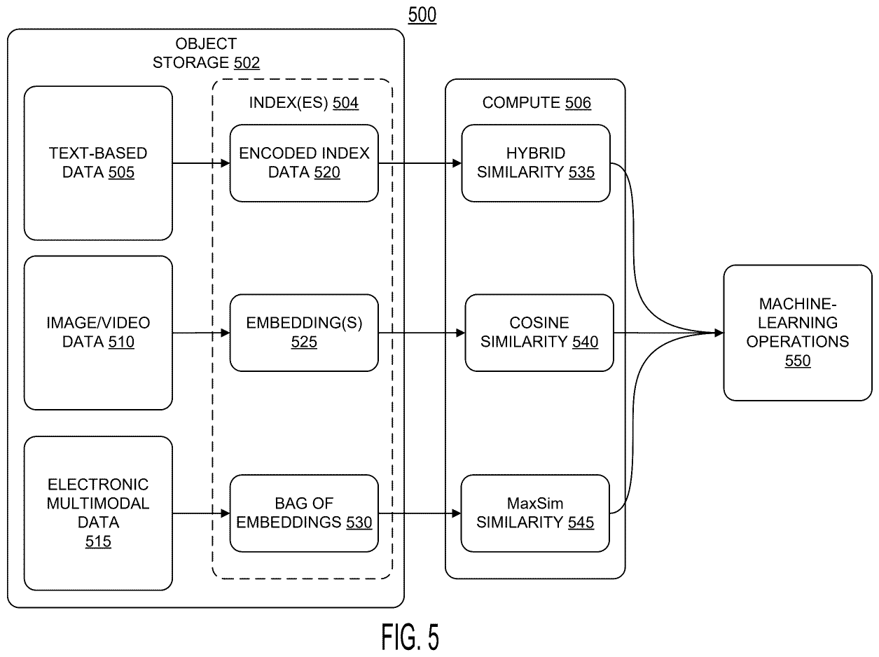

Referring to FIG. 5 in the context of the components described in connection with FIG. 4, illustrated is an example dataflow diagram 500 showing an example improved search process over object storage, in accordance with one or more implementations. As shown, in this example, different modalities of data can be stored via object storage 502 (e.g., as one or more datasets 439 of a data lake 460, etc.). The different modalities of data (e.g., samples 436 of one or more datasets 439), which may be stored within the same or within separate datasets 439, are shown as including text-based data 505 (e.g., academic papers, text files, source code files, articles, web page data, etc.), image/video data 510 (e.g., images, videos or frames thereof, etc.), and other electronic multimodal data (e.g., electronic documents having both text and image-based data, text and video-based data, PDF files, Word document files, etc.). The object storage 502 may also store data having other media modalities, such as audio data, sensor data, or any other type of data for which embeddings or indexes may be generated.

As shown, in addition to storing the samples 436 (e.g., the text-based data 505, the image/video data 510, the electronic multimodal data 515, etc.) for one or more datasets 439, the object storage 502 can also store one or more index(es) 504 for those samples 436. In this example, different types of indexes 502 are shown for each different type of data, including but not limited to encoded index data 520 (e.g., BM25 inverted index, TF-IDF index, approximate nearest neighbor (ANN) index data, etc.) for text-based data, image/video embeddings 525 (e.g., embeddings 440) are stored for image/video data 510 (and may be stored in one or more clusters 438 as described herein, and bags of embeddings 530 (e.g., bags of embeddings 440, which may be stored in one or more clusters 438 as described herein, etc.) can be stored for electronic multimodal data 515.

It should be understood that these types of indexes 504 are shown, it should be understood that any suitable type of index may be generated for any type of data. For example, in some implementations, one or more clusters 438 of embeddings 440 for text-based data 505 may be generated according to the techniques described herein, such that vector-based search operations may be performed on object storage 502. In another example, in some implementations one or more bags of embeddings 440 may be generated for the image/video data 510. In some implementations, multiple different types of indexes may be generated for the same samples 436, such that hybrid search operations can be performed.

As shown, search operations may be performed over the indexes 504 via the compute operations 506. The compute operations 506 may include any of the operations described in connection with the data processing system 405 of FIG. 4. In this example, the compute operations 506 are shown as including hybrid similarity operations 535 (e.g., hybrid BM25 and ANN search, hybrid BM25 and cluster-based embeddings search, etc.) over the encoded index data 520 to return search results from the text-based data 505, cosine similarity operations 504 (e.g., cosine similarity calculation for cluster-based embeddings search, as described in connection with FIG. 4) operations for image/video data 510, and MaxSim similarity search for bags of embeddings 530 indexes for electronic multimodal data 515, in some implementations. The compute operations 506 described herein can retrieve data directly from object storage, improving the performance of search operations over any type of dataset.

The search results returned from the compute operations 506 can be provided to one or more down-stream machine-learning operations 550, which may include but are not limited to RAG operations, chatbot operations, or search operations. For example, queries may be transmitted as part of a chatbot or language model application, in which additional data retrieved from the object storage 502 may be searched based on an input query (e.g., derived from an input prompt) and included as part of an input context for a language model. In some implementations, the search operations described herein can be implemented in connection with agent-based machine-learning operations, in which language models are executed to perform various operations. In some implementations, search operations may be performed to return relevant documents, media, or other data to users for display or presentation in one or more graphical user interfaces.

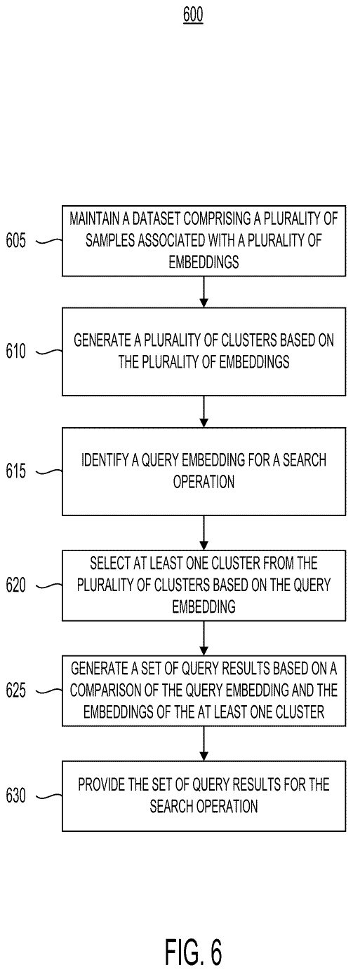

Referring to FIG. 6 in the context of the components described in connection with FIG. 4, illustrated is a flow diagram of an example method 600 of implementing improved search over object storage, in accordance with one or more implementations. The method 600 may be performed, for example, by the data processing system 405, the client device 430, the computing system 480, or any other computing system described herein. Although the method 600 is described as being performed by the data processing system 405, it should nevertheless be understood that any computing device may perform the various operations of the method 600 and communicate any results of the operations or intermediate computations relating to the operations to any other computing device described. The method 600 is described as having steps 605-630, however, it should be understood that the steps (referred to as ACTs) may be performed in any order, and that steps may be omitted, or additional steps may be performed to achieve useful results.

At ACT 605, the data processing system can maintain a dataset (e.g., the dataset 439) comprising one or more samples (e.g., samples 436) associated with corresponding embeddings (e.g., embeddings 440). The data processing system can store one or more the samples in one or more data structures of a data lake (e.g., the data lake 460), which may be or include object storage. The samples can be stored as part of a dataset. The data processing system can store the samples in a variety of formats, such as files, records, or other types of data structures. The data processing system can also store one or more embeddings (e.g., embeddings 440) or sets of embeddings (e.g., bags of embeddings 440), for example, in one or more data structures. The embeddings or bags of embeddings can be generated according to the techniques described herein.

At ACT 610, the data processing system can generate one or more clusters (e.g., clusters 438) based on the embeddings of the dataset. To do so, the data processing system can generate the plurality of clusters according to a k-means function, which can group similar embeddings together based on their vector representations. The data processing system can determine a number of clusters based at least on a number of the plurality of samples. The data processing system can update the plurality of clusters based on at least one embedding corresponding to an additional sample, which can be added to the dataset. The data processing system can use the updated clusters to improve the efficiency of search and retrieval operations.

The data processing system can use various techniques to generate the clusters, such as k-means clustering, hierarchical clustering, or other clustering algorithms. The data processing system can select a number of clusters based on configuration settings, such as a predetermined number of clusters or a dynamic number of clusters based on the number of samples. The data processing system can update the clusters periodically, such as on a scheduled basis or in response to changes in the data. The hyperparameters of the clusters may be selected such that a predetermined number of embeddings are included in each cluster. In some implementations, the number of embeddings in each cluster may be selected such that the clusters are a predetermined size (e.g., 8 megabytes, 16 megabytes, etc.).

At ACT 615, the data processing system can identify a query embedding for a search operation. The data processing system can identify an input query for a search operation, which can be received via an application programming interface (API) call. The data processing system can extract relevant metadata from the input query, such as keywords, phrases, or other search terms, to determine the context of the search operation. The data processing system can then generate a query embedding for the search operation based on the input query, which can be a vector representation of the query that captures its semantic meaning. The data processing system can use various techniques to generate the query embedding, such as using a machine learning model or a natural language processing algorithm, to create a high-dimensional vector that represents the input query. In some implementations, the data processing system can also use transformation data structures, as described herein, to transform the query embedding into an embeddings space that is tailored to the specific dataset being searched, allowing for more effective search and retrieval operations.

At ACT 620, the data processing system can select at least one cluster from the clusters of the dataset based on the query embedding. To do so, the data processing system can calculate a respective distance between the query embedding and the respective center of each cluster, which can be used to determine the similarity between the query embedding and each cluster. The data processing system can use various distance metrics, such as Euclidean distance or cosine similarity, to calculate the distance between the query embedding and each cluster center. The data processing system can then use the calculated distances to rank the clusters in order of their similarity to the query embedding.

The data processing system can select the at least one cluster based on the respective distance between the query embedding and the respective center of each cluster. The data processing system can select the cluster with the shortest distance, which can be the cluster that is most similar to the query embedding. The data processing system can also select a predetermined number of top-scoring clusters, such as the top 5 or top 10 clusters with the shortest distances. The data processing system can use various techniques to select the clusters, including threshold-based selection, where clusters with distances below a certain threshold are selected, or rank-based selection, where a predetermined number of top-scoring clusters are selected, among others. The selected clusters can then be used for further search and retrieval operations, such as retrieving the samples associated with the selected clusters.

At ACT 625, the data processing system can generate a set of query results based on a comparison of the query embedding and the embeddings of the selected cluster(s). To do so, the data processing system can compare the query embedding to each of the embeddings in the selected cluster(s) to calculate a similarity score, which can be used to rank the embeddings in order of their similarity to the query embedding. The data processing system can use various similarity metrics, such as cosine similarity or Euclidean distance, to calculate the similarity score between the query embedding and each embedding. The data processing system can then use the similarity scores to rank the embeddings and select the top-scoring embeddings, which can be used to generate the set of query results.

The data processing system can generate the set of query results based on the comparison of the query embedding and the embeddings of each of the selected clusters. The data processing system can calculate a similarity score for each embedding in each of the selected clusters and use the similarity scores to rank the embeddings across all of the selected clusters. The data processing system can then select the top-scoring embeddings, which can be used to generate the set of query results. The data processing system can use various techniques to select the top-scoring embeddings, such as selecting a predetermined number of top-scoring embeddings or selecting embeddings with similarity scores above a certain threshold. The selected embeddings can then be used to retrieve the corresponding samples, which can be returned as the query results, as described herein.

At ACT 630, the data processing system can provide the set of query results for the search operation. The data processing system can provide the set of query results in response to the request for the search operation, which can include the samples that are most similar to the query embedding. In some implementations, the data processing system can provide the set of query results in response to an API call, which can be received from a client device or other system. The data processing system can transmit the query results back to the requesting system, which can then use the results for various purposes, such as displaying the results to a user or using the results as input for further processing. The data processing system can provide the query results in a variety of formats, such as a list of samples with their corresponding similarity scores, or as a ranked list of samples with the most similar samples first. The data processing system can also provide additional metadata with the query results, such as the similarity scores or other metadata/information about the samples, to facilitate further processing or analysis.

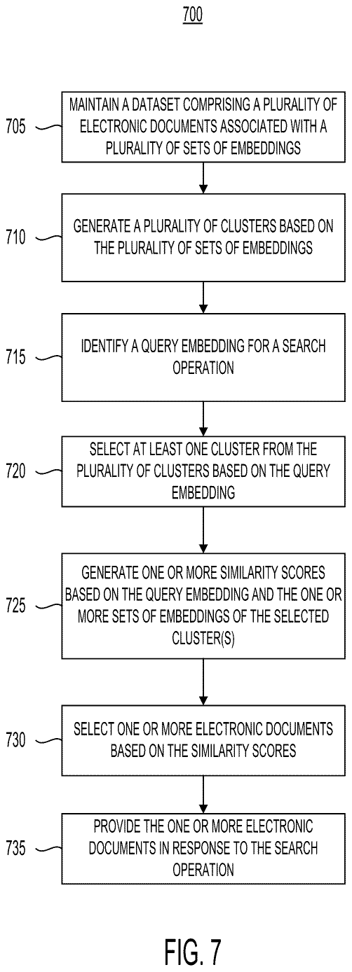

FIG. 7 illustrates a flow diagram of an example method 700 of implementing improved bag-of-vectors search over object storage, in accordance with one or more implementations. The method 700 may be performed, for example, by the data processing system 405, the client device 430, the computing system 480, or any other computing system described herein. Although the method 700 is described as being performed by the data processing system 405, it should nevertheless be understood that any computing device may perform the various operations of the method 700 and communicate any results of the operations or intermediate computations relating to the operations to any other computing device described. The method 700 is described as having steps 705-735, however, it should be understood that the steps (referred to as ACTs) may be performed in any order, and that steps may be omitted, or additional steps may be performed to achieve useful results.

At ACT 705, the data processing system can maintain a dataset (e.g., the dataset 439) comprising a plurality of electronic documents (e.g., the samples 436, images/video data 510, electronic multimodal data 515, etc.) associated with a plurality of sets of embeddings (e.g., bags of embeddings 440). The data processing system can store the electronic documents in a variety of formats, such as files, records, or other types of data structures. The data processing system can also store metadata associated with the electronic documents, such as keywords, tags, or other descriptive information. The data processing system can use the metadata to facilitate search and retrieval operations, such as searching for electronic documents based on specific keywords or tags.

The data processing system can store one or more sets of embeddings, for example, in one or more data structures. The data processing system can generate the sets of embeddings for each electronic document, which can be used to represent the semantic meaning of the electronic documents. The data processing system can use various techniques to generate the sets of embeddings, such as using a vision transformer model or other machine learning models, as described herein. For example, the data processing system can generate a set of embeddings for each electronic document using a vision transformer model, which can include generating a set of patches from the electronic document and generating an output using the vision transformer model and the set of patches. The output of the vision transformer model may be used to generate contextualized embeddings (e.g., using one or more of the language model(s) 485), which can be projected into a suitable embeddings space using one or more projection layers (e.g., the projection layers 484). As described herein, the projection layers can be trained/updated using one or more training queries associated with the dataset.

At ACT 710, the data processing system can generate one or more clusters (e.g., clusters 438) based on the plurality of sets of embeddings 440. The data processing system (e.g., data processing system 405) can generate and maintain one or more clusters, each comprising one or more sets of embeddings of the embeddings space. The data processing system can use various clustering algorithms, such as k-means or hierarchical clustering, to group similar sets of embeddings together based on their vector representations. The data processing system can calculate the centroid of each cluster, which can be used as the center of the cluster within the embeddings space. The data processing system can use the clusters to improve the efficiency of search and retrieval operations, such as by reducing the number of sets of embeddings that need to be searched. The data processing system can update the clusters dynamically based on new sets of embeddings that are added to the dataset. The data processing system can use the updated clusters to improve the accuracy of search and retrieval operations, such as by selecting the most relevant sets of embeddings that match a query. The data processing system can also use the clusters to facilitate the generation of new sets of embeddings, such as by using the centroid of a cluster as a starting point for generating new sets of embeddings.

At ACT 715, the data processing system can identify one or more query embeddings for a search operation. The data processing system can identify an input query for a search operation, which can be received via an application programming interface (API) call. The data processing system can extract relevant metadata from the input query, such as keywords, phrases, or other search terms, to determine the context of the search operation. The data processing system (e.g., data processing system 405) can tokenize an input query, which can be used to identify the individual words or tokens that make up the query. The data processing system can then generate a respective embedding for each token of the input query, which can be a vector representation of the token in a high-dimensional space. The data processing system can use various techniques to generate the embeddings, such as using a machine learning model or a natural language processing algorithm. The generated embeddings can capture the semantic meaning of each token, allowing the data processing system to compare the query to the sets of embeddings in the dataset. The data processing system can use the generated embeddings of each token as the query embeddings, which can be used to search for similar sets of embeddings in the dataset. In some implementations, the data processing system can generate transformed query embeddings based on applying one or more transformation data structures (e.g., corresponding to the dataset to be searched) to the query embeddings.

At ACT 720, the data processing system can select at least one cluster from the plurality of clusters based on the one or more query embeddings. To do so, the data processing system (e.g., data processing system 405) can select at least one cluster from the plurality of clusters based on the query embeddings and the respective center (e.g., centroid) of each cluster. The data processing system can calculate a distance or similarity metric between the query embeddings and the center of each cluster, for example, by averaging the distance or cosine similarity of each query embedding and each cluster centroid. In some implementations, the data processing system can perform a MaxSim operation, which can involve calculating the maximum similarity between the query embeddings and the centroid of each cluster, to select the most relevant clusters. The MaxSim operation can be performed by calculating the dot product of each query embedding with centroid, and selecting the maximum similarity score. The data processing system can use the calculated similarity scores to rank the clusters in order of their similarity to the query embeddings. The data processing system can select at least one cluster based on the calculated similarity scores, such as selecting the cluster with the highest similarity score or selecting a predetermined number of top-scoring clusters, as described herein. The data processing system can use the selected clusters to improve the efficiency of search and retrieval operations, such as by reducing the number of sets of embeddings that are to be searched.

At ACT 725, the data processing system can generate one or more similarity scores of based on the query embedding and the one or more sets of embeddings of the selected cluster(s). In some implementations, the data processing system can calculate the similarity scores using a MaxSim operation, which involves calculating the maximum similarity between the query embeddings and each set of embeddings in each selected cluster. The MaxSim operation can be performed by calculating the dot product of each query embedding with every embedding in the set of embeddings of each selected cluster, and selecting the maximum similarity score for that query embedding. The data processing system can use the MaxSim operation to generate a similarity score for each set of embeddings in the selected cluster, which can be used to rank the sets of embeddings in order of their similarity to the query embedding. In some implementations, the data processing system can generate the similarity scores based on transformed query embeddings and the one or more sets of embeddings of each selected cluster. For example, the data processing system can apply a transformation to the query embedding, such as a linear or non-linear transformation, to generate a transformed query embedding that is tailored to the dataset to be searched.

At ACT 730, the data processing system can select one or more electronic documents based on the similarity scores. For example, the data processing system can rank the electronic documents in order of their similarity to the query embedding, using the similarity scores calculated between the query embeddings and the sets of embeddings associated with each electronic document (e.g., each sample 436). The data processing system can select the top-scoring electronic documents, which can be returned as the search results. The data processing system can use various techniques to select the top-scoring electronic documents, such as selecting a predetermined number of top-scoring documents or selecting documents with similarity scores above a certain threshold, among any other suitable selection technique. The data processing system can retrieve the selected electronic documents from the data lake, as described herein.

At ACT 735, the data processing system can provide the selected electronic documents in response to the input query as search results. In some implementations, the data processing system can also provide additional metadata with the search results, such as the similarity scores or other information about the electronic documents, to facilitate further processing or analysis. The data processing system can return the search results in a variety of formats, such as a list of electronic documents with their corresponding similarity scores, or as a ranked list of electronic documents with the most similar documents first. In some implementations, the electronic documents (or returned portions thereof) may be provided for downstream machine-learning operations, such as RAG operations.

### C. Example Computing Environment

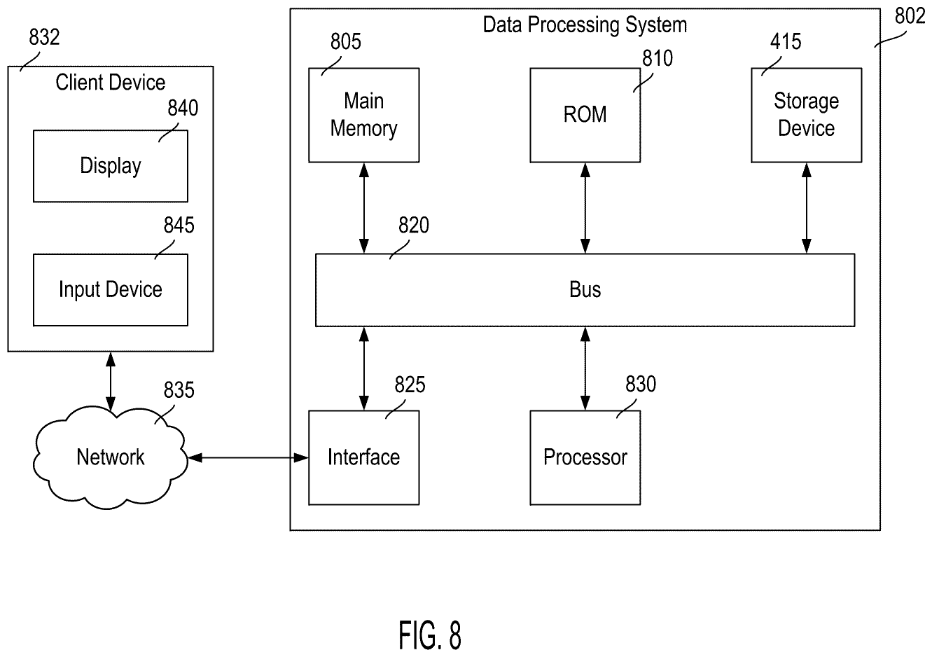

Referring to FIG. 8 an implementation of the data processing system 802 (e.g., the data processing system 105 of FIG. 1, the data processing system 405 of FIG. 4, etc.) is shown that can be used, for example, to implement the systems and methods described herein. The computing architecture described in FIG. 8 can be used for the data processing system 802 or the client device 832 (e.g., the client device 130 of FIG. 1, the client device 430 of FIG. 4, etc.). The data processing system 802 includes a bus 820 or other communication component for communicating information and a processor 830 coupled to the bus 820 for processing information. The data processing system 802 also includes main memory 805, such as a random-access memory (RAM) or other dynamic storage device, coupled to the bus 820 for storing information, and instructions to be executed by the processor 830. The main memory 805 can also be used for storing position information, temporary variables, or other intermediate information during execution of instructions by the processor 830. The data processing system 802 may further include a read only memory (ROM) 810 or other static storage device coupled to the bus 820 for storing static information and instructions for the processor 830. A storage device 815, such as a solid-state device, magnetic disk, or optical disk, is coupled to the bus 820 for persistently storing information and instructions.

The data processing system 802 may be coupled via the bus 820 to a display 840, such as a liquid crystal display, or active-matrix display, for displaying information to a user. The display 840 can be a display of the client device 832. An input device 845, such as a keyboard including alphanumeric and other keys, may be coupled to the bus 820 for communicating information, and command selections to the processor 830. The input device 845 can be a component of the client device 832. The input device 845 can include a touch screen display 840. The input device 845 can include a cursor control, such as a mouse, a trackball, or cursor direction keys, for communicating direction information and command selections to the processor 830 and for controlling cursor movement on the display 840.

The data processing system 802 can include an interface 825, such as a networking adapter. The interface 825 may be coupled to bus 820 and may be configured to enable communications with a computing or communications network 835 and/or other computing systems, e.g., the client device 832. Any type of networking configuration may be achieved using interface 825, such as wired (e.g., via Ethernet), wireless (e.g., via Wi-Fi, Bluetooth, etc.), pre-configured, ad-hoc, LAN, WAN, etc.

According to various implementations, the processes that effectuate illustrative implementations that are described herein can be achieved by the data processing system 802 in response to the processor 830 executing an arrangement of instructions contained in main memory 805. Such instructions can be read into main memory 805 from another computer-readable medium, such as the storage device 815. Execution of the arrangement of instructions contained in main memory 805 causes the data processing system 802 to perform the illustrative processes described herein. One or more processors in a multi-processing arrangement may also be employed to execute the instructions contained in main memory 805. In alternative implementations, hard-wired circuitry may be used in place of or in combination with software instructions to implement illustrative implementations. Thus, implementations are not limited to any specific combination of hardware circuitry and software.

Although an example processing system has been described in FIG. 8, implementations of the subject matter and the functional operations described in this specification can be carried out using other types of digital electronic circuitry, or in computer software, firmware, or hardware, including the structures disclosed in this specification and their structural equivalents, or in combinations of one or more of them.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the data processing system 802 could be a single module, a logic device having one or more processing modules, one or more servers, or part of a search engine.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation, element, or act herein may also embrace implementations including only a single element. References in the singular or plural form are not intended to limit the presently disclosed systems or methods, their components, acts, or elements to single or plural configurations. References to any act or element being based on any information, act, or element may include implementations where the act or element is based at least in part on any information, act, or element.

Any implementation disclosed herein may be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. In some implementations, the systems and methods described herein may be applied to environments other than those described herein. The foregoing implementations are illustrative rather than limiting of the described systems and methods. The scope of the systems and methods described herein may thus be indicated by the appended claims, rather than the foregoing description, and changes that come within the meaning and range of equivalency of the claims are embraced therein.

1. A system, comprising:
one or more processors coupled to non-transitory memory, the one or more processors configured to:
maintain a dataset comprising a plurality of samples respectively associated with a plurality of embeddings, the plurality of embeddings corresponding to an embeddings space;
generate a plurality of clusters based on the plurality of embeddings, each of the plurality of clusters comprising a respective subset of embeddings of the plurality of embeddings each of the plurality of clusters associated with a respective center within the embeddings space;
store the plurality of clusters in an object storage system;
identify a query embedding for a search operation for the dataset;
determine a respective distance between the query embedding for the search operation and each cluster of the plurality of clusters;
select at least one cluster from the plurality of clusters based on the query embedding and the respective center of the at least one cluster, wherein the at least one cluster is selected based on the respective distance between the query embedding and the at least one cluster being less than the respective distance between the query embedding and at least one second cluster of the plurality of clusters;
retrieve, from the object storage system, the respective subset of embeddings associated with the at least one cluster;
search the respective subset of embeddings of the at least one cluster by:
(i) comparing the query embedding with each cluster embedding of the respective subset of embeddings of the at least one cluster to generate a respective similarity score for the cluster embedding, and
(ii) identifying a plurality of embedding search results from the respective subset of embeddings of the at least one cluster based on the respective similarity score of each cluster embedding of the respective subset of embeddings and a threshold;
generate, based on the plurality of embedding search results, a set of query results comprising a subset of the plurality of samples that correspond to the plurality of embedding search results; and
provide the set of query results in response to the search operation.

2. The system of claim 1, wherein the one or more processors are further configured to:
identify an input query for the search operation; and
generate the query embedding based on the input query.

3. The system of claim 1, wherein the one or more processors are further configured to:
receive an additional sample to include in dataset;
generate at least one embedding corresponding to the additional sample; and
update the plurality of clusters based on the at least one embedding.

4. The system of claim 1, wherein the one or more processors are further configured to generate the plurality of clusters according to a k-means function.

5. The system of claim 1, wherein the one or more processors are further configured to:
determine a number of clusters based at least on a number of the plurality of samples; and
generate the plurality of clusters according to the number of clusters.

6. The system of claim 1, wherein the one or more processors are further configured to:
store the plurality of clusters in a remote storage; and
retrieve the at least one cluster from the remote storage based at least on the query embedding.

7. (canceled)

8. The system of claim 1, wherein the one or more processors are further configured to:
identify a plurality of electronic documents for inclusion in the dataset;
generate the plurality of embeddings based on the plurality of electronic documents; and
update the dataset to include the plurality of embeddings and respective associations to the plurality of electronic documents.

9. The system of claim 1, wherein the one or more processors are further configured to:
receive a request for the search operation via an application programming interface (API) call; and
provide the set of query results in response to the API call.

10. The system of claim 1, wherein the one or more processors are further configured to:
select a subset of clusters of the plurality of clusters, wherein a number of the subset of clusters is determined based on a number of the plurality of clusters; and
generate the set of query results based on the subset of clusters.

11. A method, comprising:
maintaining, by one or more processors coupled to non-transitory memory, a dataset comprising a plurality of samples respectively associated with a plurality of embeddings, the plurality of embeddings corresponding to an embeddings space;
generating, by the one or more processors, a plurality of clusters based on the plurality of embeddings, each of the plurality of clusters comprising a respective subset of embeddings of the plurality of embeddings each of the plurality of clusters associated with a respective center within the embeddings space;
storing, by the one or more processors, the plurality of clusters in an object storage system;
identifying, by the one or more processors, a query embedding for a search operation for the dataset;
determining, by the one or more processors, a respective distance between the query embedding for the search operation and each cluster of the plurality of clusters;
selecting, by the one or more processors, at least one cluster from the plurality of clusters based on the query embedding and the respective center of the at least one cluster. wherein the at least one cluster is selected based on the respective distance between the query embedding and the at least one cluster being less than the respective distance between the query embedding and at least one second cluster of the plurality of clusters;
retrieving, by the one or more processors, from the object storage system, the respective subset of embeddings associated with the at least one cluster;
searching, by the one or more processors, the respective subset of embeddings of the at least one cluster by:
(i) comparing the query embedding with each cluster embedding of the respective subset of embeddings of the at least one cluster to generate a respective similarity score for the cluster embedding, and
(ii) identifying a plurality of embedding search results from the respective subset of embeddings of the at least one cluster based on the respective similarity score of each cluster embedding of the respective subset of embeddings and a threshold;
generating, by the one or more processors, based on the plurality of embedding search results, a set of query results comprising a subset of the plurality of samples that correspond to the plurality of embedding search results; and
providing, by the one or more processors, the set of query results in response to the search operation.

12. The method of claim 11, further comprising:
identifying, by the one or more processors, an input query for the search operation; and
generating, by the one or more processors, the query embedding based on the input query.

13. The method of claim 11, further comprising:
receiving, by the one or more processors, an additional sample to include in the dataset;
generating, by the one or more processors, at least one embedding corresponding to the additional sample; and
updating, by the one or more processors, the plurality of clusters based on the at least one embedding.

14. The method of claim 11, wherein generating the plurality of clusters comprises generating the plurality of clusters according to a k-means function.

15. The method of claim 11, further comprising:
determining, by the one or more processors, a number of clusters based at least on a number of the plurality of samples; and
generating, by the one or more processors, the plurality of clusters according to the number of clusters.

16. The method of claim 11, further comprising:
storing, by the one or more processors, the plurality of clusters in a remote storage; and
retrieving, by the one or more processors, the at least one cluster from the remote storage based at least on the query embedding.

17. (canceled)

18. The method of claim 11, further comprising:
identifying, by the one or more processors, a plurality of electronic documents for inclusion in the dataset;
generating, by the one or more processors, the plurality of embeddings based on the plurality of electronic documents; and
updating, by the one or more processors, the dataset to include the plurality of embeddings and respective associations to the plurality of electronic documents.

19. The method of claim 11, further comprising:
receiving, by the one or more processors, a request for the search operation via an application programming interface (API) call; and
providing, by the one or more processors, the set of query results in response to the API call.

20. The method of claim 11, further comprising:
selecting, by the one or more processors, a subset of clusters of the plurality of clusters, wherein a number of the subset of clusters is determined based on a number of the plurality of clusters; and
generating, by the one or more processors, the set of query results based on the subset of clusters.
